(19) United States
(12) Patent Application Publication
(10) Pub. No.: US 2014/0009705 A1
(43) Pub. Date: Jan. 9, 2014

(54) DISPLAY UNIT AND ELECTRONIC APPARATUS

(71) Applicant: Sony Corporation, Tokyo (JP)

(72) Inventors: Yuichi Inoue, Kanagawa (JP); Akira Yoshikaie, Tokyo (JP); Sho Sakamoto, Tokyo (JP); Kenichi Takahashi, Kanagawa (JP)

(21) Appl. No.: 13/927,998

(22) Filed: Jun. 26, 2013

(30) Foreign Application Priority Data
Jul. 6, 2012 (JP) 2012-152723

(51) Int. Cl. G02B 27/22

(52) U.S. Cl. CPC G02B 27/2214
USPC 349/15; 349/61

(57) ABSTRACT

A display unit includes: a liquid crystal display section including first electrodes, a liquid crystal layer, and a second electrode, the first electrodes corresponding to a plurality of unit pixels, the second electrode being disposed to face the first electrodes with the liquid crystal layer in between; a backlight; and a light-ray control section inserted between the liquid crystal display section and the backlight, in which each of the unit pixels includes a plurality of domains or a single domain, the plurality of domains in which liquid crystal alignment differs between the domains, and each of the first electrodes is uniformly formed in each of the plurality of domains or the single domain.

### BACKGROUND

The present disclosure relates to a display unit enabling stereoscopic display, and an electronic apparatus including such a display unit.

In recent years, display units enabling stereoscopic display have been attracting attention. In stereoscopic display, a left-eye image and a right-eye image having parallax therebetween (having different perspectives) are displayed, and when a viewer sees the left-eye image and the right-eye image with his left eye and his right eyes, respectively, the viewer perceives the images as a stereoscopic image with depth. Moreover, display units capable of providing a more natural stereoscopic image to a viewer through displaying three or more images having parallax therebetween have been also developed.

Such display units are broadly classified into display units which use special glasses and display units which use no special glasses. Viewers find wearing the special glasses inconvenient; therefore, the display units which use no special glasses are desired. Examples of the display units which use no special glasses include a parallax barrier type and a lenticular lens type. In these types, a plurality of images (perspective images) having parallax therebetween are displayed together, and a viewer sees images different depending on a relative positional relationship (angle) between a display unit and the viewer. For example, in Japanese Unexamined Patent Application Publication No. H03-119889, a parallax barrier type display unit using a liquid crystal device as a barrier is disclosed.

### SUMMARY

In general, high image quality is desired in display units, and display units enabling stereoscopic display are also expected to achieve high image quality.

It is desirable to provide a display unit and an electronic apparatus which are capable of enhancing image quality.

According to an embodiment of the disclosure, there is provided a first display unit including: a liquid crystal display section including first electrodes, a liquid crystal layer, and a second electrode, the first electrodes corresponding to a plurality of unit pixels, the second electrode being disposed to face the first electrodes with the liquid crystal layer in between; a backlight; and a light-ray control section inserted between the liquid crystal display section and the backlight, in which each of the unit pixels includes a plurality of domains or a single domain, the plurality of domains in which liquid crystal alignment differs between the domains, and each of the first electrodes is uniformly formed in each of the plurality of domains or the single domain.

According to an embodiment of the disclosure, there is provided a second display unit including: a liquid crystal display section including first electrodes, a liquid crystal layer, and a second electrode, the first electrodes corresponding to a plurality of unit pixels, the second electrode being disposed to face the first electrodes with the liquid crystal layer in between; a backlight; and a light-ray control section inserted between the liquid crystal display section and the backlight, in which each of the first electrodes is uniformly formed in each of the unit pixels, and the second electrode has holes in portions corresponding to the respective unit pixels.

According to an embodiment of the disclosure, there is provided an electronic apparatus provided with a display unit and a control section which performs operation control with use of the display unit, the display unit including: a liquid crystal display section including first electrodes, a liquid crystal layer, and a second electrode, the first electrodes corresponding to a plurality of unit pixels, the second electrode being disposed to face the first electrodes with the liquid crystal layer in between; a backlight; and a light-ray control section inserted between the liquid crystal display section and the backlight, in which each of the unit pixels includes a plurality of domains or a single domain, the plurality of domains in which liquid crystal alignment differs between the domains, and each of the first electrodes is uniformly formed in each of the plurality of domains or the single domain. The electronic apparatus according to the embodiment of the disclosure may include, for example, a television, a digital camera, a personal computer, a video camera, or a portable terminal device such as a cellular phone.

In the first display unit and the electronic apparatus according to the embodiments of the disclosure, light emitted from the backlight exits through the light-ray control section and the liquid crystal display section. At this time, in the liquid crystal display section, light is modulated by the unit pixels each of which includes a plurality of domains or a single domain. In each of the unit pixels, each of the first electrodes is uniformly formed in each of the plurality of domains or the single domain.

In the second display unit according to the embodiment of the disclosure, light which has been emitted from the backlight and has passed through the light-ray control section exits through the liquid crystal display section. At this time, in the liquid crystal display section, the light is modulated by the respective unit pixels. In each of the unit pixels, each of the first electrodes is uniformly formed.

In the first display unit and the electronic apparatus according to the embodiments of the disclosure, each of the first electrodes is uniformly formed in each of the plurality of domains or the single domain; therefore, image quality is allowed to be enhanced.

In the second display unit according to the embodiment of the disclosure, each of the first electrodes is uniformly formed in each of the unit pixels; therefore, image quality is allowed to be enhanced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a block diagram illustrating a configuration example of a stereoscopic display unit according to an embodiment of the disclosure.

FIGS. 2A and 2B are explanatory diagrams illustrating a configuration example of the stereoscopic display unit illustrated in FIG. 1.

FIG. 3 is a block diagram illustrating a configuration example of a display drive section illustrated in FIG. 1.

FIG. 4 is an explanatory diagram illustrating a configuration example of a display section illustrated in FIG. 1.

FIG. 5 is a circuit diagram illustrating a configuration example of a sub-pixel illustrated in FIG. 4.

FIG. 6 is a sectional view illustrating a configuration example of the display section illustrated in FIG. 1.

FIGS. 7A and 7B are explanatory diagrams illustrating a configuration example of a sub-pixel according to a first embodiment.

FIGS. 8A to 8C are explanatory diagrams illustrating operation examples of the sub-pixel illustrated in FIGS. 7A and 7B.

FIG. 9 is an explanatory diagram illustrating a configuration example of a barrier section illustrated in FIG. 1.

FIG. 10 is an explanatory diagram illustrating a group configuration example of opening-closing sections illustrated in FIG. 9.

FIGS. 11A to 11D are schematic views illustrating a relationship between the display section and the barrier section illustrated in FIG. 1.

FIG. 12 is a schematic view illustrating an operation example of the stereoscopic display unit illustrated in FIG. 1.

FIG. 13 is a schematic view illustrating another operation example of the stereoscopic display unit illustrated in FIG. 1.

FIG. 14 is an explanatory diagram for describing crosstalk in the stereoscopic display unit illustrated in FIG. 1.

FIG. 15 is a plot illustrating a characteristic example of a display section according to the first embodiment.

FIGS. 16A to 16C are explanatory diagrams illustrating a configuration example of a sub-pixel according to Comparative Example 1.

FIG. 17 is an explanatory diagram illustrating an operation example of the sub-pixel illustrated in FIGS. 16A to 16C.

FIG. 18 is a plot illustrating a characteristic example of a display section according to Comparative Example 1.

FIGS. 19A and 19B are explanatory diagrams illustrating a configuration example of a sub-pixel according to Comparative Example 2.

FIG. 20 is a plot illustrating a characteristic example of a display section according to Comparative Example 2.

FIG. 21 is a plot illustrating moire in the stereoscopic display unit illustrated in FIG. 1.

FIGS. 22A to 22C are explanatory diagrams for describing moire in the stereoscopic display unit illustrated in FIG. 1.

FIGS. 23A to 23C are other explanatory diagrams for describing moire in the stereoscopic display unit illustrated in FIG. 1.

FIGS. 24A and 24B are explanatory diagrams illustrating a configuration example of a stereoscopic display unit according to Comparative Example 3.

FIG. 25 is a plot illustrating moire in the stereoscopic display unit illustrated in FIGS. 24A and 24B.

FIG. 26 is an explanatory diagram illustrating a configuration example of a display section according to a modification of the first embodiment.

FIG. 27 is an explanatory diagram illustrating a configuration example of a sub-pixel illustrated in FIG. 26.

FIG. 28 is a sectional view illustrating a configuration example of a display section according to a second embodiment.

FIGS. 29A to 29C are explanatory diagrams illustrating a configuration example of a sub-pixel illustrated in FIG. 28.

FIGS. 30A to 30C are explanatory diagrams illustrating a configuration example of a sub-pixel according to a third embodiment.

FIGS. 31A to 31C are explanatory diagrams illustrating a configuration example of a sub-pixel according to a fourth embodiment.

FIG. 32 is a sectional view illustrating a configuration example of a display section according to a fifth embodiment.

FIGS. 33A and 33B are explanatory diagrams illustrating a configuration example of a sub-pixel illustrated in FIG. 32.

FIGS. 34A and 34B are explanatory diagrams illustrating an operation example of the sub-pixel illustrated in FIG. 32.

FIG. 35 is a perspective view illustrating an appearance of a television to which any one of the stereoscopic display units according to the embodiments is applied.

### DETAILED DESCRIPTION

Some embodiments of the present disclosure will be described in detail below referring to the accompanying drawings. It is to be noted that description will be given in the following order.

1. First Embodiment

2. Second Embodiment

3. Third Embodiment

4. Fourth Embodiment

5. Fifth Embodiment

6. Application Examples

### 1. First Embodiment

### Configuration Example

### Entire Configuration Example

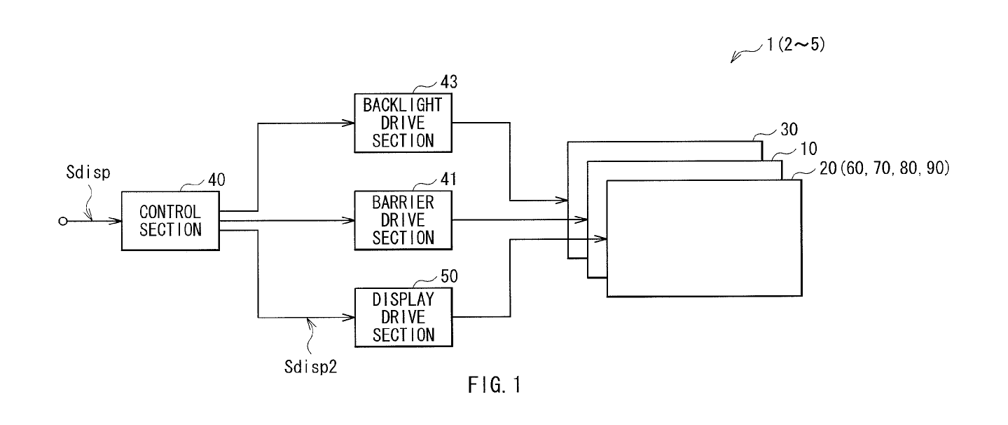

FIG. 1 illustrates a configuration example of a stereoscopic display unit 1 according to a first embodiment. The stereoscopic display unit 1 is a parallax barrier type display unit using a liquid crystal barrier. The stereoscopic display unit 1 includes a control section 40, a backlight drive section 43, a backlight 30, a barrier drive section 41, a barrier section 10, a display drive section 50, and a display section 20.

The control section 40 is a circuit which supplies a control signal to each of the backlight drive section 43, the barrier drive section 41, and the display drive section 50, based on an image signal Sdisp externally supplied thereto, and thereby controls these sections to operate in synchronization with one another. More specifically, the control section 40 supplies a backlight control signal, a barrier control signal, and an image signal Sdisp2 which is generated based on the image signal Sdisp to the backlight drive section 43, the barrier drive section 41, and the display drive section 50, respectively. In this case, the image signal Sdisp2 is an image signal S2D including one perspective image when the stereoscopic display unit 1 performs normal display (two-dimensional display), and is an image signal S3D including a plurality of (eight in this example) perspective images when the stereoscopic display unit 1 performs stereoscopic display, as will be described later.

The backlight drive section 43 drives the backlight 30 based on the backlight control signal supplied from the control section 40. The backlight 30 has a function of emitting light toward the barrier section 10 and the display section 20 by surface emission. The backlight 30 may be configured of, for example, LEDs (Light Emitting Diodes) or CCFLs (Cold Cathode Fluorescent Lamps).

The barrier drive section 41 drives the barrier section 10 based on the barrier control signal supplied from the control section 40. The barrier section 10 allows light incident thereon to pass therethrough (an open operation) or blocks the light incident thereon (a close operation), and the barrier section 10 includes a plurality of opening-closing sections 11 and 12 (which will be described later) formed with use of a liquid crystal.

The display drive section 50 drives the display section 20 based on the image signal Sdisp2 supplied from the control section 40. In this example, the display section 20 is a liquid crystal display section, and drives liquid crystal display elements to modulate light incident thereon, and thereby performs display.

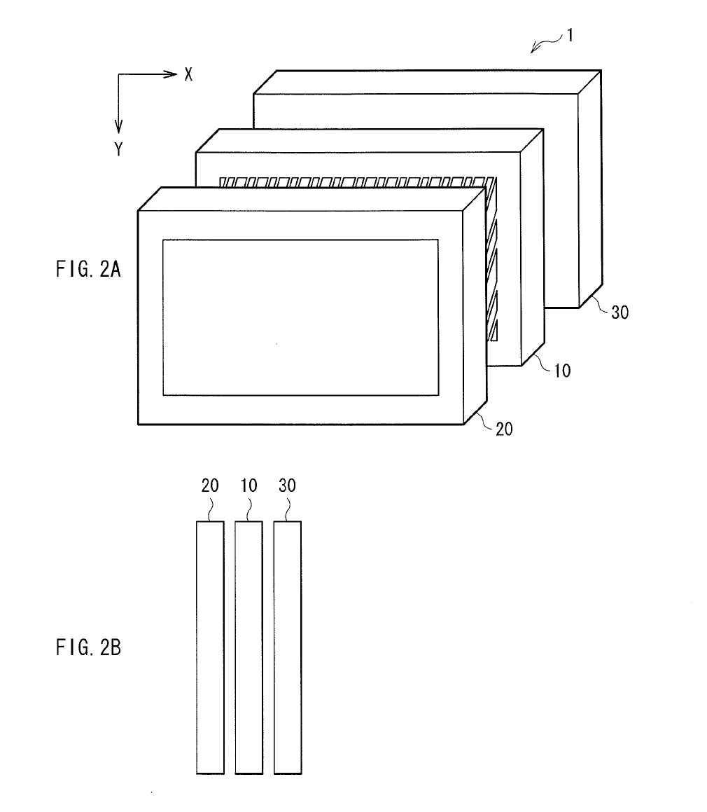

FIGS. 2A and 2B illustrate a configuration example of a main part of the stereoscopic display unit 1. FIG. 2A illustrates an exploded perspective configuration of the stereoscopic display unit 1, and FIG. 2B illustrates a side view of the stereoscopic display unit 1. As illustrated in FIGS. 2A and 2B, in the stereoscopic display unit 1, the backlight 30, the barrier section 10, and the display section 20 are arranged in this order. In other words, light which has been emitted from the backlight 30 and has passed through the barrier section 10 is modulated by the display section 20, and then the light reaches a viewer.

### (Display Drive Section 50 and Display Section 20)

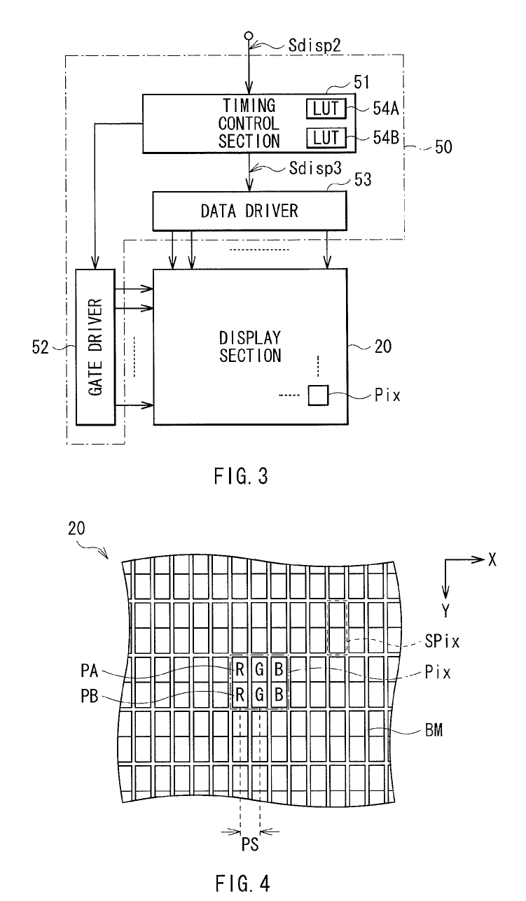

FIG. 3 illustrates an example of a block diagram of the display drive section 50. The display drive section 50 includes a timing control section 51, a gate driver 52, and a data driver 53. The timing control section 51 controls drive timings of the gate driver 52 and the data driver 53, and generates an image signal Sdisp3 based on the image signal Sdisp2 supplied from the control section 40, and then supplies the image signal Sdisp3 to the data driver 53. The gate driver 52 sequentially selects pixels Pix in the display section 20 from one row to another in response to timing control by the timing control section 51 to line-sequentially scan the pixels Pix. The data driver 53 supplies a pixel signal based on the image signal Sdisp3 to each of the pixels Pix in the display section 20. More specifically, the data driver 53 performs D/A (digital-to-analog) conversion based on the image signal Sdisp3 to generate a pixel signal which is an analog signal, and then supplies the pixel signal to each of the pixels Pix.

The timing control section 51 has LUTs (Look Up Tables) 54A and 54B. The LUTs 54A and 54B are tables for performing so-called gamma correction on pixel information (luminance information) for each of the pixels Pix included in the image signal Sdisp2. The LUT 54A is a table for a sub-pixel portion PA (which will be described later) of a sub-pixel SPix, and the LUT 54B is a table for a sub-pixel portion PB (which will be described later) of the sub-pixel SPix. The timing control section 51 performs, on the pixel information (the luminance information), different gamma corrections with use of the LUTs 54A and 54B to generate the image signal Sdisp3. The data driver 53 supplies a pixel signal generated with use of the LUT 54A to the sub-pixel portion PA (which will be described later) of the sub-pixel SPix and supplies a pixel signal generated with use of the LUT 54B to the sub-pixel portion PB (which will be described later) of the sub-pixel SPix. As will be described later, in the display section 20, the sub-pixel portions PA and PB perform display based on the respective pixel signals. In other words, the display section 20 performs display by halftone driving in which the sub-pixel portions PA and PB display one piece of pixel information with difference gamma characteristics.

FIG. 4 illustrates a configuration example of the display section 20. The pixels Pix are arranged in a matrix form in the display section 20. Each of the pixels Pix includes three sub-pixels SPix corresponding to red (R), green (G), and blue (B). The sub-pixels SPix are arranged at a predetermined pitch (a sub-pixel pitch PS) in a horizontal direction. A so-called black matrix BM is formed between the sub-pixels SPix to block light incident thereon. Thus, in the display section 20, mixing of red (R), green (G), and blue (B) is less likely to occur. Each of the sub-pixels SPix includes the sub-pixel portions PA and PB arranged side by side in a vertical direction Y. It is to be noted that, in this example, sizes of the sub-pixel portions PA and PB are equal to each other; however the sizes of the sub-pixel portions PA and PB are not limited thereto, and, for example, the sub-pixel portion PA may be larger in size than the sub-pixel portion PB.

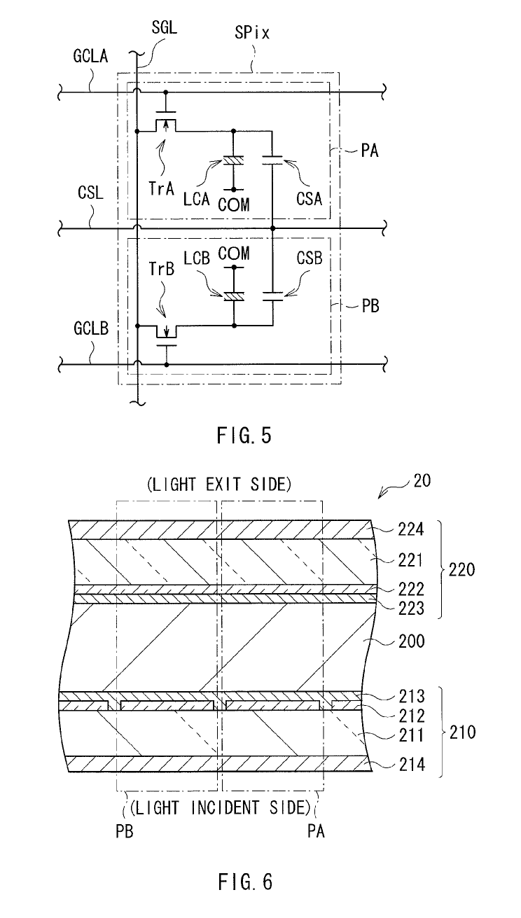

FIG. 5 illustrates an example of a circuit diagram of the sub-pixel SPix. The sub-pixel portion PA of the sub-pixel SPix includes a TFT element TrA configured of, for example, a MOS-FET (Metal Oxide Semiconductor Field Effect Transistor), a liquid crystal element LCA, and a retention capacitor CsA. In the TFT element TrA, a gate thereof is connected to a gate line GCLA, a source thereof is connected to a data line SGL, and a drain thereof is connected to one end of the liquid crystal element LCA and one end of the retention capacitor CsA. In the liquid crystal element LCA, the one end thereof is connected to the drain of the TFT element TrA, and the other end thereof is connected to a common electrode COM (a counter electrode 222 which will be described later) to be grounded. In the retention capacitor CsA, the one end thereof is connected to the drain of the TFT element TrA, and the other end thereof is connected to a retention capacitor line CSL. Likewise, the sub-pixel portion PB of the sub-pixel SPix includes a TFT element TrB configured of, for example, a MOS-FET, a liquid crystal element LCB, and a retention capacitor CsB. In the TFT element TrB, a gate thereof is connected to a gate line GCLB, a source thereof is connected to the data line SGL, and a drain thereof is connected to one end of the liquid crystal element LCB and one end of the retention capacitor CsB. In the liquid crystal element LCB, the one end thereof is connected to the drain of the TFT element TrB, and the other end thereof is connected to the common electrode COM (the counter electrode 222 which will be described later) to be grounded. In the retention capacitor CsB, the one end thereof is connected to the drain of the TFT element TrB, and the other end thereof is connected to the retention capacitor line CSL. The gate lines GCLA and GCLB are connected to the gate driver 52, and the data line SGL is connected to the data driver 53.

FIG. 6 illustrates a sectional configuration example of the display section 20. The display section 20 is configured through sealing a liquid crystal layer 200 between a drive substrate 210 and a counter substrate 220.

The drive substrate 210 includes a transparent substrate 211, pixel electrodes 212, an alignment film 213, and a polarizing plate 214. The transparent substrate 211 may be made of, for example, glass, and the TFT elements TrA and TrB and the like (not illustrated) are formed on a surface of the transparent substrate 211. The pixel electrodes 212 are disposed corresponding to the respective sub-pixel portions PA and PB on the transparent substrate 211. Each of the pixel electrodes 212 may be configured of, for example, a transparent conductive film of ITO (Indium Tin Oxide) or the like, and the pixel electrodes 212 are uniformly formed in respective regions of the sub-pixel portions PA and PB. The alignment film 213 is formed on the pixel electrodes 212. The alignment film 213 is subjected to so-called photo-alignment treatment for determining an alignment direction of liquid crystal molecules M in the liquid crystal layer 200 by, for example, ultraviolet irradiation. The polarizing plate 214 is bonded to a surface of the transparent substrate 211 opposite to a surface where the pixel electrodes 212 and the like are formed of the transparent substrate 211.

The counter substrate 220 includes a transparent substrate 221, a counter electrode 222, an alignment film 223, and a polarizing plate 224. As with the transparent substrate 211, the transparent substrate 221 may be made of, for example, glass, and a color filter or the black matrix BM which are not illustrated are formed on a surface of the transparent substrate 221. The counter electrode 222 is disposed on the transparent substrate 221 as an electrode common to the sub-pixels SPix. The counter electrode 222 may be configured of a transparent conductive film of ITO or the like, and in this example, the counter electrode 222 is uniformly formed throughout the display section 20. The alignment film 223 is formed on the counter electrode 222. As with the alignment film 213, the alignment film 223 is subjected to so-called photo-alignment treatment. The polarizing plate 224 is bonded to a surface of the transparent substrate 221 opposite to a surface where the counter electrode 222 and the like are formed of the transparent substrate 221.

The liquid crystal layer 200 includes, for example, the liquid crystal molecules M with negative dielectric anisotropy. The liquid crystal layer 200 includes liquid crystal molecules M vertically aligned by an alignment film. In other words, the liquid crystal layer 200 functions as a so-called VA (Vertical Alignment) liquid crystal.

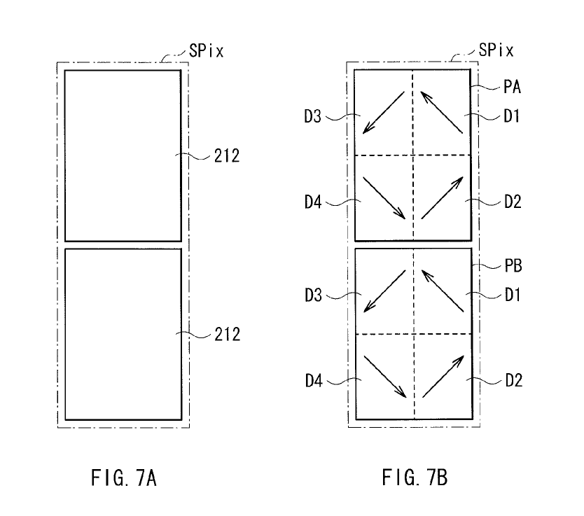

FIGS. 7A and 7B illustrate the sub-pixel SPix, and FIG. 7A illustrates the pixel electrodes 212, and FIG. 7B schematically illustrates average alignment directions of liquid crystal molecules M upon voltage application. As illustrated in FIG. 7A, the pixel electrodes 212 are uniformly formed corresponding to the sub-pixel portions PA and PB. Moreover, in the display section 20, as illustrated in FIG. 7B, each of the sub-pixel portions PA and PB has a plurality of regions (domains D1 to D4) with different alignment directions of the liquid crystal molecules M. These domains D1 to D4 are formed by photo-alignment treatment on the alignment films 213 and 223 so as to have the alignment direction of the liquid crystal molecules M differing between the domains D1 to D4, and the domains D1 to D4 have a substantially equal area.

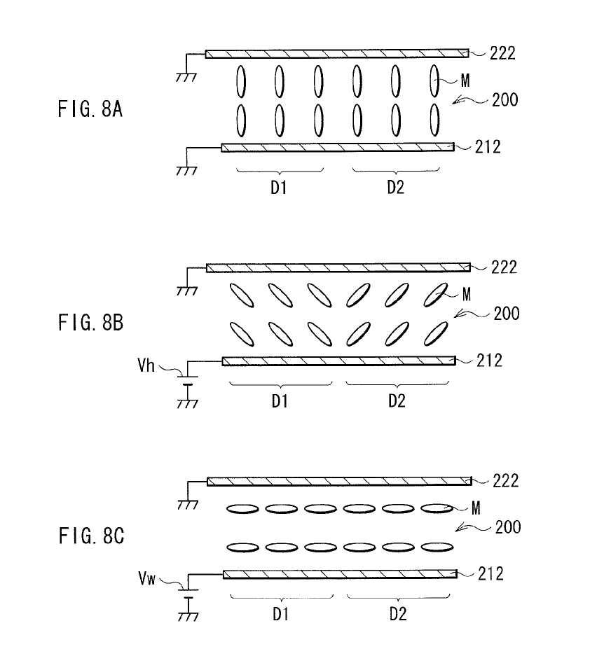

FIGS. 8A to 8C schematically illustrate alignment of the liquid crystal molecules M in two different domains (in this example, the domains D1 and D2). FIG. 8A illustrates alignment of the liquid crystal molecules M in the case where a pixel signal with 0 V is applied to the pixel electrode 212, FIG. 8B illustrates alignment of the liquid crystal molecules M in the case where a pixel signal with a voltage Vh is applied to the pixel electrode 212, and FIG. 8C illustrates alignment of the liquid crystal molecules M in the case where a pixel signal with a voltage Vw larger than the voltage Vh is applied to the pixel electrode 212. In this case, the voltage Vh is, for example, about 4 V, and the voltage Vw is, for example, about 8 V.

In the case where the pixel signal with 0 V is applied to the pixel electrode 212, as illustrated in FIG. 8A, long axes of the liquid crystal molecules M are aligned in a direction perpendicular to a substrate surface. In this case, in the sub-pixel portions PA and PB, light transmittance becomes sufficiently low, and black display is performed. Moreover, in the case where the pixel signal with the voltage Vw is applied to the pixel electrode 212, as illustrated in FIG. 8C, the long axes of the liquid crystal molecules M are aligned in a direction parallel to the substrate surface. In this case, in the sub-pixel portions PA and PB, light transmittance becomes high, and so-called white display is performed.

On the other hand, in the case where the pixel signal with the voltage Vh is applied to the pixel electrode 212, as illustrated in FIG. 8B, the long axes of the liquid crystal molecules M are tilted toward an intermediate direction between the direction illustrated in FIG. 8A and the direction illustrated in FIG. 8C. At this time, as illustrated in FIG. 8B, the liquid crystal molecules M in the domain D1 on the left in the drawing and the liquid crystal molecules M in the domain D2 on the right in the drawing are tilted at a substantially equal tilt degree (angle) in directions different from each other. In this case, in the sub-pixel portions PA and PB, light transmittance is at a moderate level, and halftone display is performed.

Thus, in the display section 20, when the pixel signal is applied to the pixel electrodes 212, the liquid crystal molecules M in the domains D1 to D4 are aligned in a direction differing between the domains D1 to D4. At this time, the sub-pixel portions PA and PB are driven by different pixel signals generated with use of the LUTs 54A and 54B, respectively, specifically in a halftone state; therefore, for example, the liquid crystal molecules M in the domain D1 of the sub-pixel portion PA and the liquid crystal molecules M in the domain D1 of the sub-pixel portion PB are aligned in directions different from each other. The liquid crystal molecules M in the domains D2 to D4 of the sub-pixel portion PA and the liquid crystal molecules M in the domains D2 to D4 of the sub-pixel portion PB are aligned in a similar manner. Accordingly, in the display section 20, viewing angle characteristics are allowed to be enhanced.

### (Barrier Section 10)

The barrier section 10 is a parallax barrier configured of liquid crystal barriers. The barrier section 10 will be described in detail below.

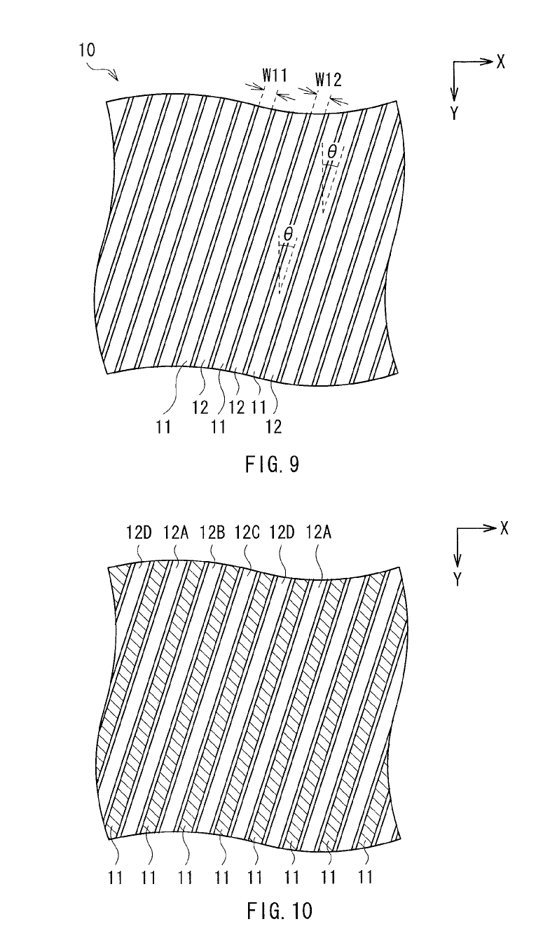

FIG. 9 illustrates a configuration example of the barrier section 10. The barrier section 10 includes a plurality of opening-closing sections (liquid crystal barriers) 11 and 12 allowing light to pass therethrough or blocking light. The opening-closing sections 11 and 12 are arranged to extend in one direction (in this example, in a direction forming a predetermined angle θ from a vertical direction Y) on an XY plane, and are alternately arranged in a horizontal direction X. In this example, a width W12 of each of the opening-closing sections 12 is substantially equal to the sub-pixel pitch PS in the display section 20. Thus, as will be described later, possibility of generation of moire during stereoscopic display is allowed to be reduced. Moreover, in this example, a width W11 of each of the opening-closing sections 11 and the width W12 of each of the opening-closing sections 12 are substantially equal to each other. It is to be noted that a magnitude relation of the widths of the opening-closing sections 11 and 12 are not limited thereto, and the width W11 may be larger than the width W12 (W11>W12) or may be smaller than the width W12 (W11<W12).

These opening-closing sections 11 and 12 perform different operations depending on whether the stereoscopic display unit 1 performs normal display (two-dimensional display) or stereoscopic display. In other words, as will be described later, the opening-closing sections 11 are turned into an open state (a transmission state) when normal display is performed, and are turned into a close state (a blocking state) when stereoscopic display is performed. On the other hand, as will be described later, the opening-closing sections 12 are turned into an open state (a transmission state) when normal display is performed, and are turned into an open state (a transmission state) in a time-divisional manner when stereoscopic display is performed. More specifically, the opening-closing sections 12 are divided into a plurality of groups, and when stereoscopic display is performed, a plurality of opening-closing sections 12 belonging to a same group perform an open operation and a close operation at same timing. Groups of the opening-closing sections 12 will be described below.

FIG. 10 illustrates a group configuration example of the opening-closing sections 12. In this example, the opening-closing sections 12 are divided into four groups A to D. More specifically, as illustrated in FIG. 10, the opening-closing sections 12 (opening-closing sections 12A) belonging to the group A, the opening-closing sections 12 (opening-closing sections 12B) belonging to the group B, the opening-closing sections 12 (opening-closing sections 12C) belonging to the group C, and the opening-closing section 12 (opening-closing sections 12D) belonging to the group D are alternately arranged in this order.

The barrier drive section 41 drives a plurality of opening-closing sections 12 belonging to a same group to perform the open operation and the close operation at same timing when stereoscopic display is performed. More specifically, as will be described later, a plurality of opening-closing sections 12A belonging to the group A perform an open-and-close operation together, and then, a plurality of opening-closing sections 12B belonging to the group B perform an open-and-close operation together. Next, a plurality of opening-closing sections 12C belonging to the group C perform an open-and-close operation together, and then, a plurality of opening-closing sections 12D belonging to the group D perform an open-and-close operation together. Thus, the barrier drive section 41 alternately drives the opening-closing sections 12A to 12D to perform the open operation and close operation in a time-divisional manner.

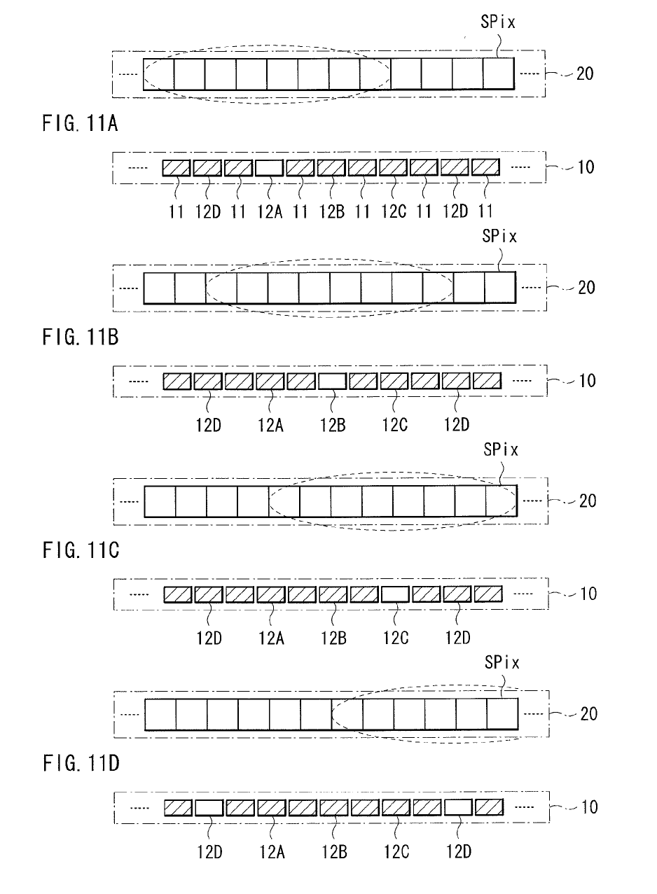

FIGS. 11A to 11D schematically illustrate, with use of sectional configurations, states of the barrier section 10 when stereoscopic display is performed. In this example, one opening-closing section 12A is assigned to eight sub-pixels SPix of the display section 20. Likewise, one opening-closing section 12B is assigned to eight sub-pixels SPix, one opening-closing section 12C is assigned to eight sub-pixels SPix, and one opening-closing section 12D is assigned to eight sub-pixels SPix. It is to be noted that the embodiment of the present disclosure is not limited thereto, and each one of the opening-closing sections 12A, 12B, 12C, and 12D may be assigned to eight pixels Pix instead of eight sub-pixels SPix in the display section 20. In FIGS. 11A to 11D, opening-closing sections blocking light in the opening-closing sections 11 and 12 (12A to 12D) of the barrier section 10 are shaded.

When the stereoscopic display unit 1 performs stereoscopic display, the image signal S3D is supplied to the display drive section 50, and the display section 20 performs display based on the image signal S3D. Then, in the barrier section 10, the opening-closing sections 11 are kept in the close state (the blocking state), and the opening-closing sections 12 (the opening-closing sections 12A to 12D) perform the open operation and the close operation in a time-divisional manner in synchronization with display by the display section 20.

More specifically, in the case where the barrier drive section 41 turns the opening-closing sections 12A into the open state (the transmission state), as illustrated in FIG. 11A, in the display section 20, eight adjacent sub-pixels SPix to which each of the opening-closing sections 12A is assigned display pieces of pixel information P1 to P8 corresponding to eight perspective images. Likewise, in the case where the barrier drive section 41 turns the opening-closing sections 12B into the open state (the transmission state), as illustrated in FIG. 11B, in the display section 20, eight adjacent sub-pixels SPix to which each of the opening-closing sections 12B is assigned display pieces of pixel information P1 to P8 corresponding to eight perspective images. Moreover, in the case where the barrier drive section 41 turns the opening-closing sections 12C into the open state (the transmission state), as illustrated in FIG. 11C, in the display section 20, eight adjacent sub-pixels SPix to which each of the opening-closing sections 12C is assigned display pieces of pixel information P1 to P8 corresponding to eight perspective images. Then, in the case where the barrier drive section 41 turns the opening-closing sections 12D into the open state (the transmission state), as illustrated in FIG. 11D, in the display section 20, eight adjacent sub-pixels SPix to which each of the opening-closing sections 12D is assigned display pieces of pixel information P1 to P8 corresponding to eight perspective images.

Thus, as will be described later, a viewer may see different perspective images with his left and right eyes, thereby perceiving displayed images as a stereoscopic image. In the stereoscopic display unit 1, images are displayed while the opening-closing sections 12A to 12D perform switching between the open state and the close state in a time-divisional manner; therefore, resolution of the display unit is allowed to be enhanced, as will be described later.

Moreover, in the case where normal display (two-dimensional display) is performed, the display section 20 displays a normal two-dimensional image based on the image signal S2D, and in the barrier section 10, all of the opening-closing sections 11 and the opening-closing sections 12 (the opening-closing sections 12A to 12D) are kept in the open state (in the transmission state). Accordingly, the viewer sees the normal two-dimensional image as it is displayed on the display section 20.

The sub-pixel portions PA and PB correspond to a specific example of “unit pixels” in an embodiment of the disclosure. The pixel electrodes 212 correspond to a specific example of “first electrodes” in an embodiment of the disclosure. The counter electrode 222 corresponds to a specific example of “second electrode” in an embodiment of the disclosure. The barrier section 10 corresponds to a specific example of “light-ray control section” in an embodiment of the disclosure.

### [Operation and Function]

Next, an operation and a function of the stereoscopic display unit 1 according to the embodiment will be described below.

### (Brief Description of Entire Operation)

First, referring to FIG. 1 and the like, an entire operation of the stereoscopic display unit 1 will be briefly described below. The control section 40 controls the backlight drive section 43, the barrier drive section 41, and the display drive section 50 based on the image signal Sdisp externally supplied thereto. The backlight drive section 43 drives the backlight 30 based on the backlight control signal supplied from the control section 40. The backlight 30 emits light toward the barrier section 10 by surface emission. The barrier drive section 41 controls the barrier section 10 based on the barrier control signal supplied from the control section 40. The opening-closing sections 11 and 12 of the barrier section 10 perform the open operation and the close operation based on an instruction from the barrier drive section 41. The display drive section 50 drives the display section 20 based on the image signal Sdisp2 supplied from the control section 40. The display section 20 performs display through modulating light which has been emitted from the backlight 30 and has passed through the opening-closing sections 11 and 12 of the barrier section 10.

### (Specific Operation)

Next, a specific operation when stereoscopic display is performed will be described below.

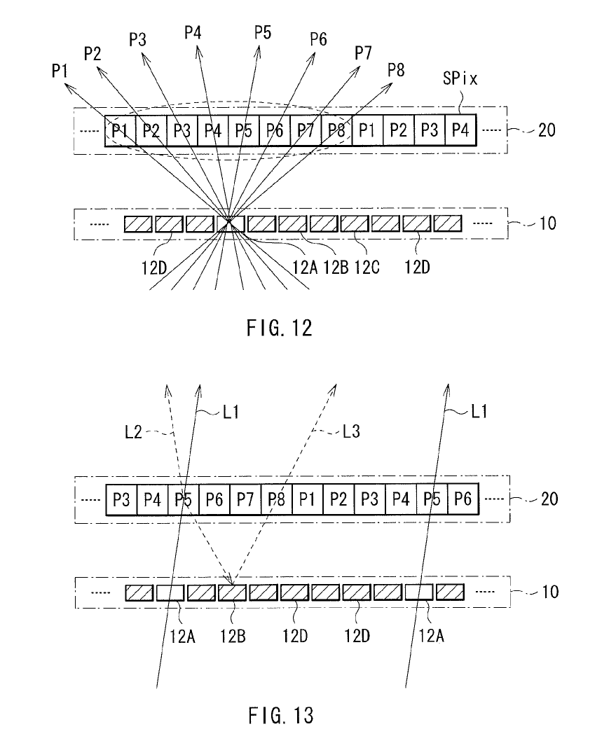

FIG. 12 illustrates operation examples of the display section 20 and the barrier section 10 when the barrier drive section 41 turns the opening-closing sections 12A into the open state (the transmission state). In this case, while the opening-closing section 12A is turned into the open state (the transmission state), the opening-closing sections 12B to 12D are turned into the close state (the blocking state), and sub-pixels SPix disposed around the opening-closing section 12A of the display section 20 display the respective pieces of pixel information P1 to P8 corresponding to eight perspective images included in the image signal S3D. Thus, light rays corresponding to the respective pieces of pixel information P1 to P8 are output with their respective angles limited according to a positional relationship between each of the sub-pixels Spix and the opening-closing section 12A. Accordingly, for example, a viewer viewing from the front of the display screen of the stereoscopic display unit 1 may be allowed to see a stereoscopic image through seeing the pixel information P5 with his left eye and pixel information P4 with his right eye. It is to be noted that, in this case, a case where the barrier drive section 41 turns the opening-closing sections 12A into the open state is described; a similar operation is performed in the case where the opening-closing sections 12B to 12D are turned into the open state.

Thus, the viewer sees different pieces of pixel information from among the pieces of pixel information P1 to P8 with his left eye and his right eye, thereby perceiving such pieces of pixel information as a stereoscopic image. Moreover, since images are displayed while alternately opening and closing the opening-closing sections 12A to 12D in a time-divisional manner, the viewer sees an average of images displayed at positions different from one another. Therefore, the stereoscopic display unit 1 is capable of achieving resolution four times as high as that in the case where only the opening-closing sections 12A are included. In other words, necessary resolution of the stereoscopic display unit 1 is only ½ (=⅛×4) of resolution in the case of two-dimensional display.

### (About Crosstalk)

As illustrated in FIG. 12, during stereoscopic display, it is desirable that the viewer see different perspective images with his left and right eyes. However, as will be described below, the viewer may see a mixture of a perspective image which is supposed to be seen and another perspective image different from the perspective image.

FIG. 13 schematically illustrates a case where one eye of the viewer sees a fifth perspective image. In this example, light which has been emitted from the backlight 30 and has passed through the opening-closing sections 12A in the open state goes straight into the sub-pixels SPix displaying the pixel information P5, and is output as light L1. At this time, a part of light incident on the sub-pixels SPix may be scattered to travel in a direction different from a desired direction. In other words, for example, in FIG. 13, as indicated by light L2, the incident light may be diffracted or refracted by an electrode pattern, a wiring pattern, the liquid crystal layer 200, or the like of the display section 20, or may be scattered by a color filter, the planarizing plates 214 or 224, or the like. Moreover, in FIG. 13, as indicated by light L3, the incident light may be reflected by a metal or a multilayer thin film of the display section 20 and then be reflected by the barrier section 10 to be output through the sub-pixel SPix displaying a different perspective image (in this case, the sub-pixel SPix displaying the pixel information P8).

Thus, when light relating to a certain perspective image is scattered to change its travel direction, the scattered light may be mixed into light relating to another perspective image. In other words, in this case, different perspective images are mixed (crosstalk), and the viewer feels as if image quality is degraded.

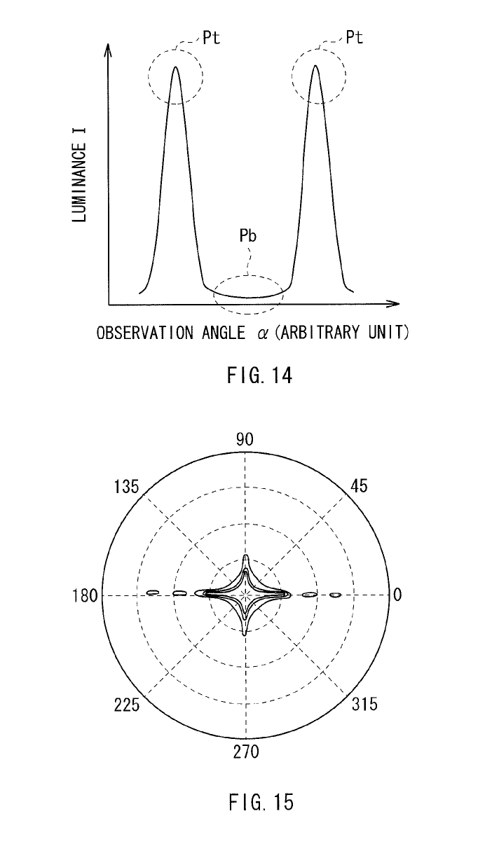

FIG. 14 illustrates crosstalk characteristics of the stereoscopic display unit 1. The crosstalk characteristics illustrated in FIG. 14 are obtained in the following manner. First, the display section 20 displays eight perspective images including a certain perspective image which is entirely white (a white image) and the other perspective images which are entirely black (black images). Then, the barrier section 10 keeps only the opening-closing sections 12 belonging to a certain group (for example, the opening-closing sections 12A belonging to the group A) in the open state (the transmission state), and keeps the opening-closing sections 12 belonging to the other groups in the close state (blocking state). Then, luminance I is measured while changing an observation angle α in a horizontal direction to obtain the crosstalk characteristics illustrated in FIG. 14.

As illustrated in FIG. 14, the luminance I is high (a portion Pt) at the observation angle α at which the viewer sees the light L1 traveling in a straight line illustrated in FIG. 13, and the luminance I is low (a portion Pb) at the observation angle α other than the above-described observation angle α. A part of the luminance I in the portion Pb is caused by scattering of light in the display section 20 illustrated in FIG. 13. As the luminance I in the portion Pb is increased, in addition to a perspective image which is supposed to be seen, a perspective image different from the above-described perspective image is displayed, thereby causing degradation in image quality.

FIG. 15 illustrates a distribution of transmitted light when only the display section 20 is irradiated with laser light. A center of a concentric circle corresponds to a position of light traveling in a straight line (for example, the light L1 in FIG. 13), and a diameter direction of the concentric circle corresponds to a polar angle. Since the display section 20 is configured to uniformly form the pixel electrodes 212 and the counter electrode 222 in the sub-pixels SPix, compared to the following comparative examples, scattering of light is allowed to be reduced. Thus, the luminance I in the portion Pb in the crosstalk characteristics (refer to FIG. 14) is allowed to be reduced, and image quality is allowed to be enhanced accordingly.

Next, functions of the embodiment will be described below, compared to some comparative examples.

### Comparative Example 1

In Comparative Example 1, a display section 20R is configured with use of a so-called PVA (Patterned Vertical Alignment) type display panel. Other configurations are similar to those in the embodiment (refer to FIG. 1 and the like).

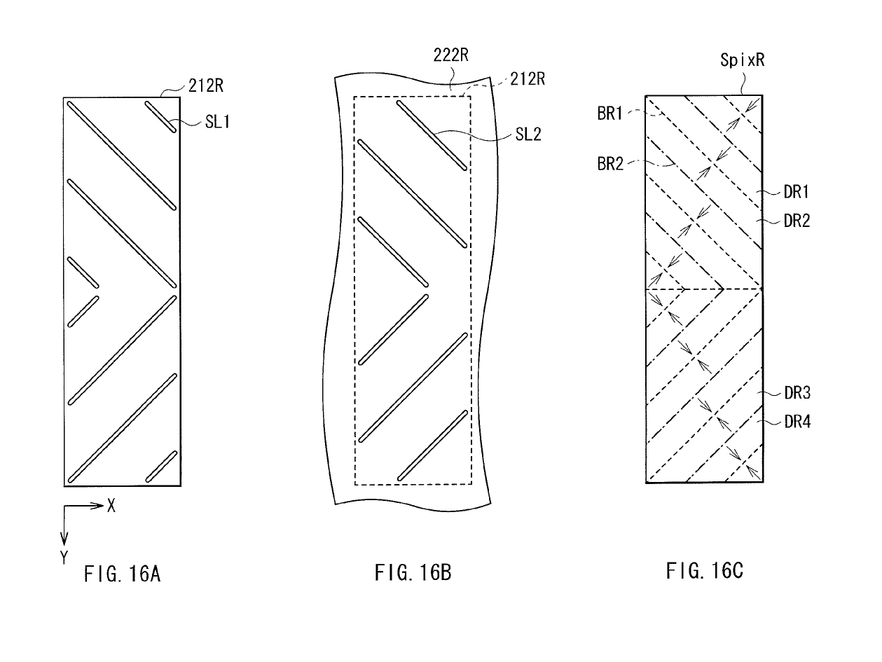

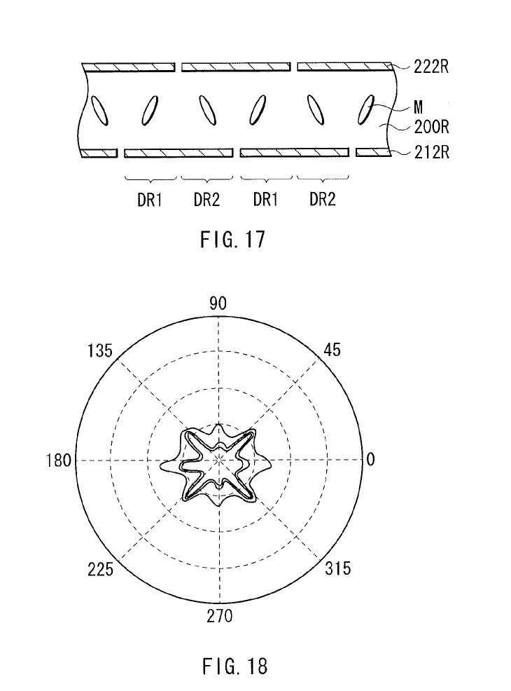

FIGS. 16A, 16B, and 16C illustrate a configuration example of the display section 20R. FIG. 16A illustrates a pixel electrode 212R, FIG. 16B illustrates a counter electrode 222R, and FIG. 16C schematically illustrates alignment of liquid crystal molecules M in a sub-pixel SPixR. FIG. 17 schematically illustrates a direction of liquid crystal molecules M in an upper half of the sub-pixel SPixR.

As illustrated in FIG. 16A, a plurality of slits SL1 are provided to the pixel electrode 212R. In this example, the slits SL1 in the upper half of the sub-pixel SPixR extend in a direction rotated clockwise by about 45° from the horizontal direction X and are formed at predetermined intervals, and the slits SL1 in a lower half of the sub-pixel SPixR extend in a direction rotated counterclockwise by about 45° from the horizontal direction X and are formed at predetermined intervals.

As illustrated in FIG. 16B, as with the pixel electrode 212R, a plurality of slits SL2 are provided to the counter electrode 222R. In this example, the slits SL2 in an upper half of a region corresponding to the pixel electrode 212R extend in a direction rotated clockwise by about 45° from the horizontal direction X and are formed at predetermined intervals, and the slits SL2 in a lower half of the region corresponding to the pixel electrode 212R extend in a direction rotated counterclockwise by about 45° from the horizontal direction X and are formed at predetermined intervals. At this time, the slits SL2 are formed in portions not corresponding to the slits SL1. More specifically, the slit SL1 formed in the pixel electrode 212R and the slits SL2 formed in the counter electrode 222R are alternately arranged.

In this configuration, as illustrated in FIG. 17, the liquid crystal molecules M in the upper half of the sub-pixel SPixR are aligned in a direction according to a relative positional relationship between the slits SL1 and SL2, and two kinds of domains DR1 and DR2 are alternately formed. It is to be noted that, in FIG. 17, only the upper half of the sub-pixel SPixR is described; however, the lower half of the sub-pixel SPixR has a configuration similar to the upper half of the sub-pixel SPixR.

Thus, as illustrated in FIG. 16C, four kinds of domains DR1 to DR4 are formed in the sub-pixel SPixR. In other words, the domains DR1 and DR2 separated by portions corresponding to the slits SL1 and SL2 (domain boundaries BR1 and BR2) are alternately formed in the upper half of the sub-pixel SPixR, and the domains DR3 and DR4 separated by portions corresponding to the slits SL1 and SL2 in a similar manner are alternately formed in the lower half of the sub-pixel SPixR.

FIG. 18 illustrates a distribution of transmitted light when only the display section 20R is irradiated with laser light. As illustrated in FIG. 18, in the display section 20R according to Comparative Example 1, unlike the case in the embodiment (refer to FIG. 15), it is found out that the transmitted light is scattered in oblique directions (at about 45°, about 135°, about 225°, and about 315°). In other words, as illustrated in FIGS. 16A to 16C, in the display section 20R, the slits SL1 and SL2 are arranged in oblique directions; therefore, diffraction or the like of incident light may be caused by this electrode pattern or a liquid crystal layer 200R aligned according to this electrode pattern to cause scattering in oblique directions. Thus, in the display section 20R, light is more scattered; therefore, the luminance I in the portion Pb in the crosstalk characteristics (refer to FIG. 14) may be increased to cause degradation in image quality.

On the other hand, in the display section 20 according to the embodiment, the pixel electrodes 212 and the counter electrode 222 are uniformly formed in the sub-pixel SPix; therefore, an electrode pattern such as slits which may cause scattering does not exist. Accordingly, scattering of light is allowed to be reduced, and image quality is allowed to be enhanced.

### Comparative Example 2

In Comparative Example 2, a display section 20S is configured with use of a so-called PSA (Polymer Sustained Alignment) type display panel. Other configurations are similar to those in the embodiment (refer to FIG. 1 and the like).

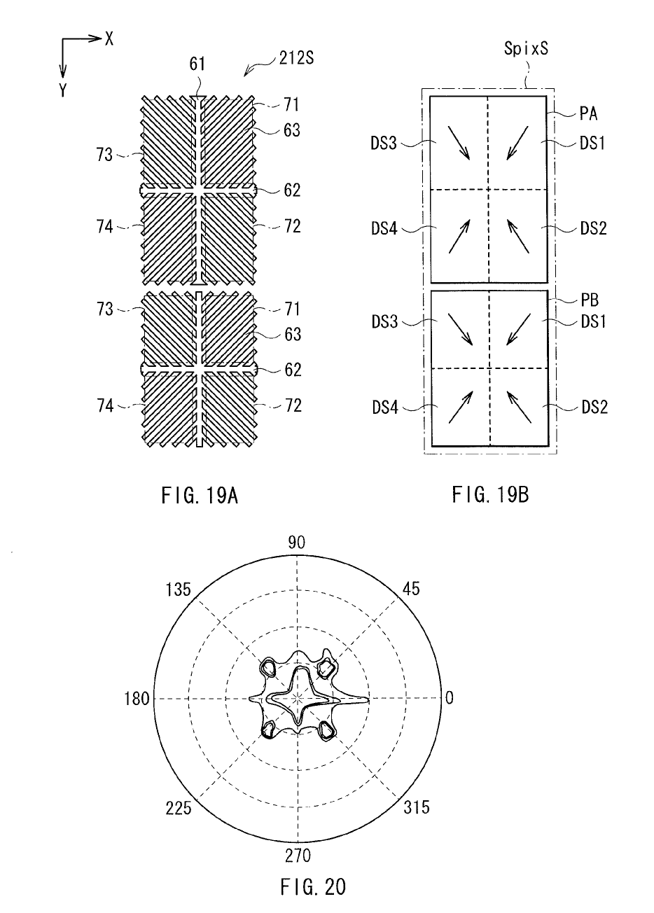

FIGS. 19A and 19B illustrate a configuration example of the display section 20S according to Comparative Example 2. FIG. 19A illustrates the pixel electrode 212S, and FIG. 19B schematically illustrates an average alignment direction of liquid crystal molecules M in a sub-pixel SPixS.

The pixel electrode 212S is formed in a similar electrode pattern in the sub-pixel portions PA and PB. As illustrated in FIG. 19A, the pixel electrode 212S includes trunk portions 61 and 62 and branch portions 63. The trunk portion 61 is so formed as to extend in the vertical direction Y, and the trunk portion 62 is so formed as to extend in the horizontal direction X and as to intersect with the trunk portion 61. The branch portions 63 in each of four branch regions 71 to 74 separated by the trunk portion 61 and the trunk portion 62 are so formed as to extend from the trunk portion 61 and the trunk portion 62. The branch portions 63 in each of the branch regions 71 to 74 extend in a same direction. The branch portions 63 in each of the branch regions 71 and 74 extend in a direction rotated counterclockwise by a predetermined angle φ (for example, 45°) from the horizontal direction X, and the branch portions 63 in each of the branch regions 72 and 73 extend in a direction rotated clockwise by a predetermined angle φ (for example, 45°) from the horizontal direction X.

Thus, as illustrated in FIG. 19B, four domains DS1 to DS4 corresponding to the branch regions 71 to 74 are formed in each of the sub-pixel portions PA and PB in the sub-pixel SPixS.

FIG. 20 illustrates a distribution of transmitted light when only the display section 20S is irradiated with laser light. As illustrated in FIG. 20, in the display section 20S according to Comparative Example 2, unlike the case in the embodiment (refer to FIG. 15), it is found out that the transmitted light is scattered in oblique directions (at about 45°, about 135°, about 225°, and about 315°). In other words, as illustrated in FIGS. 19A and 19B, since the branch portions 63 are arranged in oblique directions, diffraction or the like of incident light may be caused by this electrode pattern or a liquid crystal layer 200S aligned according to this electrode pattern to cause scattering in oblique directions. Thus, in the display section 20S, light is more scattered; therefore, the luminance I in the portion Pb in the crosstalk characteristics (refer to FIG. 14) may be increased to cause degradation in image quality.

On the other hand, in the display section 20 according to the embodiment, in the sub-pixel SPix, since the pixel electrodes 212 and the counter electrode 222 are uniformly formed, an electrode pattern such as the branch portions which may cause scattering is not formed. Therefore, scattering of light is allowed to be reduced, and image quality is allowed to be enhanced.

### (About Moire)

In general, in a parallax barrier type stereoscopic display unit, opening-closing sections are arranged side by side in a barrier section, and sub-pixels are arranged side by side in a display section; therefore, moire may be generated during stereoscopic display. Moire is classified into moire MA caused by shapes of the opening-closing sections and the sub-pixels and moire MB caused by diffraction of light.

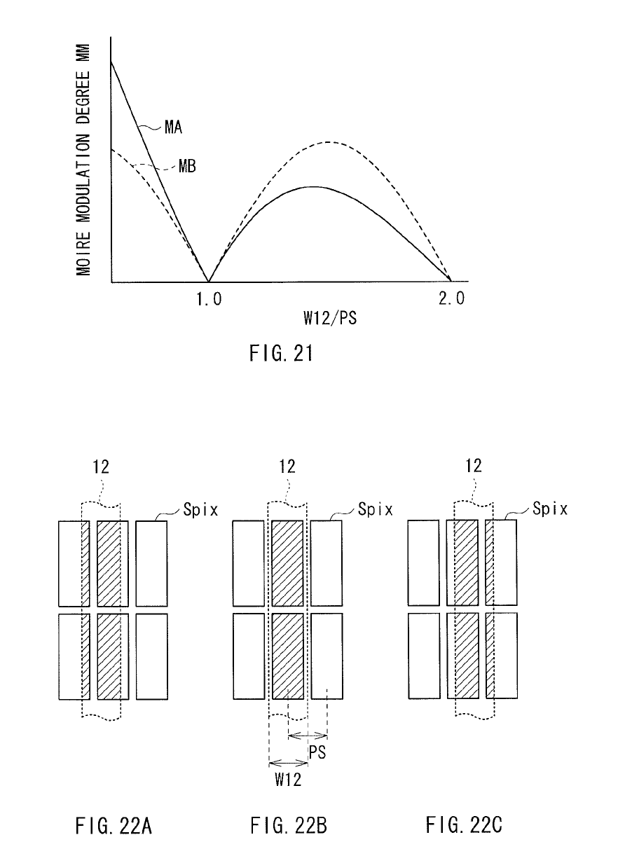

FIG. 21 illustrates simulation results of the moire MA and the moire MB in the stereoscopic display unit 1. In FIG. 21, a horizontal axis indicates a value (W12/PS) obtained through dividing a width W12 of each of the opening-closing sections 12 turned into a transmission state during stereoscopic display by the sub-pixel pitch PS of the sub-pixel SPix, and a vertical axis indicates a moire modulation degree MM. As used herein, the moire modulation degree MM refers to variation in luminance caused by moire in a display screen, and is represented by (maximum luminance value−minimum luminance value)/(maximum luminance value+minimum luminance value).

In this simulation of the moire modulation degree MM, diffraction calculation is performed in consideration of the shape of each of the sub-pixels SPix and the shape of each of the opening-closing sections 12 turned into the transmission state during stereoscopic display, based on illumination calculation according to partial coherence theory in consideration of spatial coherence.

As illustrated in FIG. 21, the moire modulation degrees MM relating to the moire MA and the moire MB are decreased with an increase in W12/PS from 0 (zero), and then both become sufficiently small when W12/PS is 1. When W12/PS is further increased, these moire modulation degrees MM are increased, and then decreased to become sufficiently small again when W12/PS is 2. Thus, in the case where the width W12 of each of the opening-closing sections 12 is equal to an integral multiple of the sub-pixel pitch PS, the moire modulation degrees MM relating to the moire MA and the moire MB are both reduced, and possibility of generation of moire is reduced.

In the stereoscopic display unit 1, since the width W12 of each of the opening-closing sections 12 and the sub-pixel pitch PS of the sub-pixel SPix are substantially equal to each other, as illustrated in FIG. 21, both the moire modulation degrees MM relating to the moire MA and the moire MB are allowed to be reduced. Accordingly, possibility of generation of moire is allowed to be reduced, and degradation in image quality is allowed to b suppressed.

Next, the moire MA caused by the shapes of the opening-closing sections and the sub-pixels will be described in more detail below.

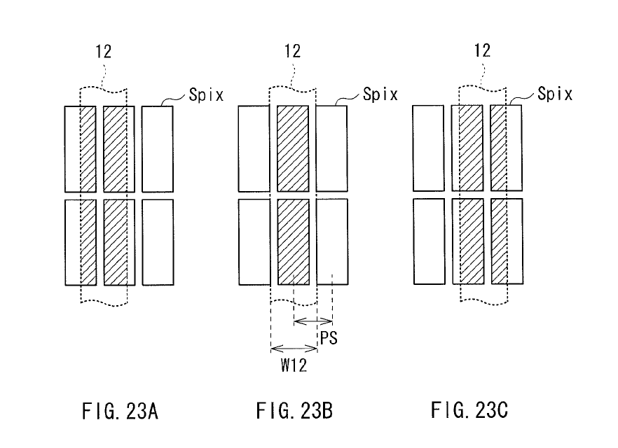

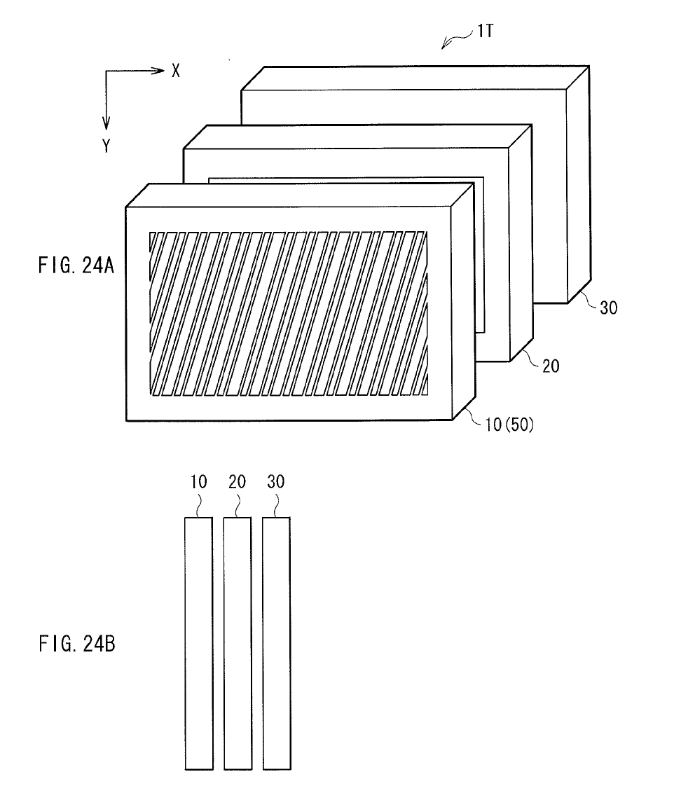

FIGS. 22A to 22C illustrate a relative positional relationship between the opening-closing section 12 in the barrier section 10 and the sub-pixels SPix in the display section 20. FIGS. 23A to 23C illustrate a relative positional relationship between the opening-closing section 12 and the sub-pixels SPix in the case where the width W12 of the opening-closing section 12 is wider than the sub-pixel pitch PS. It is to be noted that, in these drawings, the opening-closing sections 11 which are turned into the close state during stereoscopic display are not illustrated. Moreover, for convenience of description, the opening-closing section 12 extending in the vertical direction Y is illustrated; however, as illustrated in FIG. 9, even in the case where the opening-closing section 12 extends in a direction forming the predetermined angle θ from the vertical direction Y, the relative positional relationship between the opening-closing section 12 and the sub-pixels SPix is similar.

The positional relationships illustrated in FIGS. 22A to 22C and FIGS. 23A to 23C may be caused by, for example, the observation angle α when the viewer sees a display screen. More specifically, for example, when the viewer sees the display screen from the front, the positional relationships illustrated in FIGS. 22B and 23B are established, and when the viewer sees the display screen from a right side from the front, the positional relationships illustrated in FIGS. 22A and 23A are established, and when the viewer sees the display screen from a left side from the front, the positional relationship illustrated in FIGS. 22C and 23C are established.

The viewer sees portions (portions marked by diagonal lines in FIGS. 22A to 22C and FIGS. 23A to 23C) on which the opening-closing section 12 is superimposed of the sub-pixels Spix. In the stereoscopic display unit 1, since the width W12 of each of the opening-closing sections 12 is substantially equal to the sub-pixel pitch PS of the sub-pixel SPix, as illustrated in FIGS. 22A to 22C, an area of the seen portions of the sub-pixels SPix is allowed to be substantially constant irrespective of the observation angle α. In other words, for example, in the case where the width W12 of each of the opening-closing sections 12 is wider than the sub-pixel pitch PS, as illustrated in FIGS. 23A to 23C, the area of the seen portions of the sub-pixels SPix is varied by the observation angle α. In this case, luminance is varied depending on the observation angle α; therefore, as illustrated in FIG. 21, the moire modulation degree MM relating to the moire MA is increased. On the other hand, in the stereoscopic display unit 1, as illustrated in FIGS. 22A to 22C, the area of the seen portions of the sub-pixels SPix is allowed to be substantially constant irrespective of the observation angle α; therefore, the moire modulation degree MM relating to the moire MA is allowed to be reduced, and degradation in image quality is allowed to be suppressed.

Next, functions of the embodiment will be described, compared to a comparative example.

### Comparative Example 3

Comparative Example 3 is different from the stereoscopic display unit 1 in that the positions of the barrier section 10 and the display section 20 are changed. Other configurations are similar to those in the embodiment (refer to FIG. 1 and the like).

FIGS. 24A and 24B illustrate a configuration example of a main part of a stereoscopic display unit 1T according to Comparative Example 3. FIG. 24A illustrates an exploded perspective configuration of the stereoscopic display unit 1T, and FIG. 24B illustrates a side view of the stereoscopic display unit 1T. In the stereoscopic display unit 1T, the backlight 30, the display section 20, and the barrier section 10 are arranged in this order. In the stereoscopic display unit 1T, light which has been emitted from the backlight 30 and has passed through the display section 20 reaches a viewer through the barrier section 10.

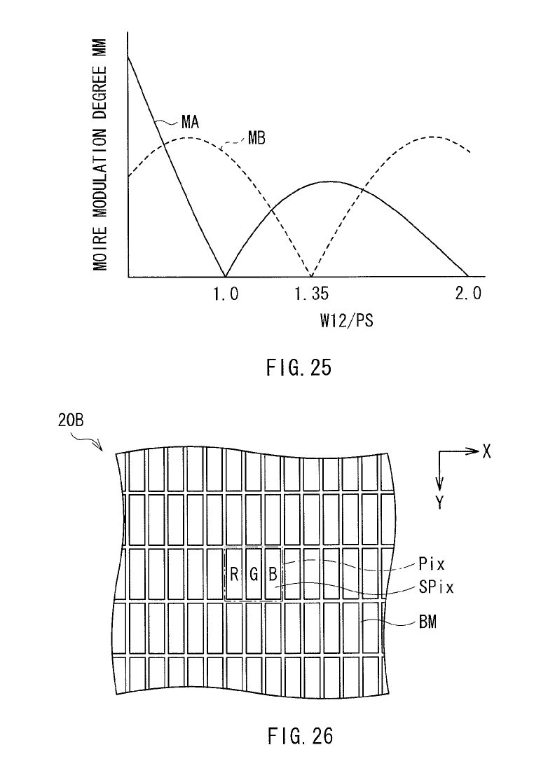

FIG. 25 illustrates simulation results of the moire MA and the moire MB in the stereoscopic display unit 1T. Also in the stereoscopic display unit 1T, the moire modulation degree MM relating to the moire MA is the same as that in the stereoscopic display unit 1 according to the embodiment (refer to FIG. 21). On the other hand, the moire modulation degree MM relating to the moire MB is increased with an increase in W12/PS from 0 (zero), and then is decreased to become sufficiently small when W12/PS is 1.35. Then, when W12/PS is further increased, the moire modulation degree MM is increased. Thus, in the stereoscopic display unit 1T, the value of W12/PS at which the moire modulation degree MM relating to the moire MA becomes sufficiently low is different from the value of W12/PS at which the moire modulation degree MM relating to the moire MB becomes sufficiently low. Accordingly, it is difficult to allow both the moire MA and the moire MB to be reduced to a low level.

On the other hand, in the stereoscopic display unit 1 according to the embodiment, since the display section 20, the backlight 30, and the barrier section 10 are arranged in this order, as illustrated in FIG. 21, the value of W12/PS at which the moire modulation degree MM relating to the moire MA becomes sufficiently low is allowed to be substantially equal to the value of W12/PS at which the moire modulation degree MM relating to the moire MB becomes sufficiently low. Therefore, in the stereoscopic display unit 1, both the moire MA and the moire MB are allowed to be reduced to a low level, and image quality is allowed to be enhanced accordingly.

### [Effects]

As described above, in the embodiment, since the pixel electrodes and the counter electrode are uniformly formed in each of the sub-pixels, an electrode pattern such as slits causing scattering does not exist. Accordingly, scattering of light is allowed to be reduced, and image quality is allowed to be enhanced.

Moreover, in the embodiment, the display section, the backlight, and the barrier section are arranged in this order, and the width of each of the opening-closing sections 12 is substantially equal to the sub-pixel pitch; therefore, possibility of generation of moire is allowed to be reduced, and image quality is allowed to be enhanced.

### [Modification 1-1]

In the above-described embodiment, the alignment films 213 and 223 are subjected to so-called photo-alignment treatment; however, the alignment films 213 and 223 is not exclusively subjected to the photo-alignment treatment, and may be subjected to, for example, so-called rubbing.

### [Modification 1-2]

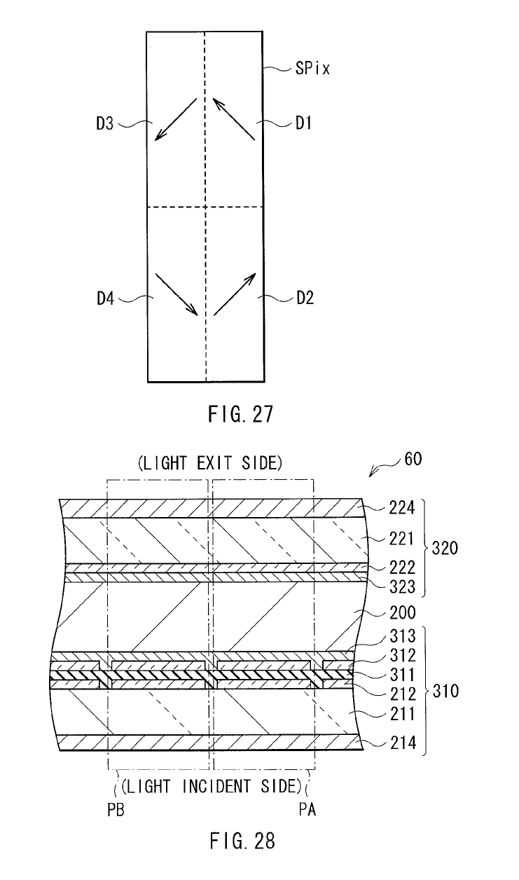

In the above-described embodiment, each of the sub-pixels SPix includes the sub-pixel portions PA and PB; however, the configuration of each of the sub-pixels SPix is not limited thereto. For example, as illustrated in FIG. 26, each of the sub-pixels SPix may not include sub-pixel portions, and may be driven as one unit. In this case, as illustrated in FIG. 27, each of the sub-pixels SPix preferably includes four domains D1 to D4.

### [Modification 1-3]

In the above-described embodiment, the width W12 of each of the opening-closing sections 12 is substantially equal to the sub-pixel pitch PS; however, the width W12 is not limited thereto, and, for example, the width W12 may be substantially equal to an integral multiple of the sub-pixel pitch PS. More specifically, the width W12 of each of the opening-closing sections 12 may be substantially equal to twice the sub-pixel pitch PS. Also in this case, as illustrated in FIG. 21, both the moire modulation degrees MM relating to the moire MA and the moire MB are allowed to be reduced; therefore, possibility of generation of moire is allowed to be reduced, and degradation in image quality is allowed to be suppressed.

### 2. Second Embodiment

Next, a stereoscopic display unit 2 according to a second embodiment will be described below. In the embodiment, transparent electrodes are additionally provided to the display section to determine alignment of the liquid crystal molecules M. It is to be noted that like components are denoted by like numerals as of the stereoscopic display unit 1 according to the above-described first embodiment and the like and will not be further described.

FIG. 28 illustrates a sectional configuration example of a display section 60 according to the embodiment. The display section 60 includes a drive substrate 310 and a counter substrate 320. The drive substrate 310 includes an insulating layer 311, transparent electrodes 312, and an alignment film 313. The insulating layer 311 is formed on the pixel electrodes 212. The insulating layer 311 may be made of, for example, SiN. The transparent electrodes 312 are formed in respective regions corresponding to the sub-pixel portions PA and PB on the insulating layer 311. Each of the transparent electrodes 312 may be configured of, for example, a transparent conductive film of ITO or the like, and includes a plurality of the branch portions 83, as will be described later. The alignment film 313 is formed on the transparent electrodes 312. The counter substrate 320 includes an alignment film 323. The alignment film 323 is formed on the counter electrode 222. In this example, an UV-curable monomer is mixed in the liquid crystal layer 200.

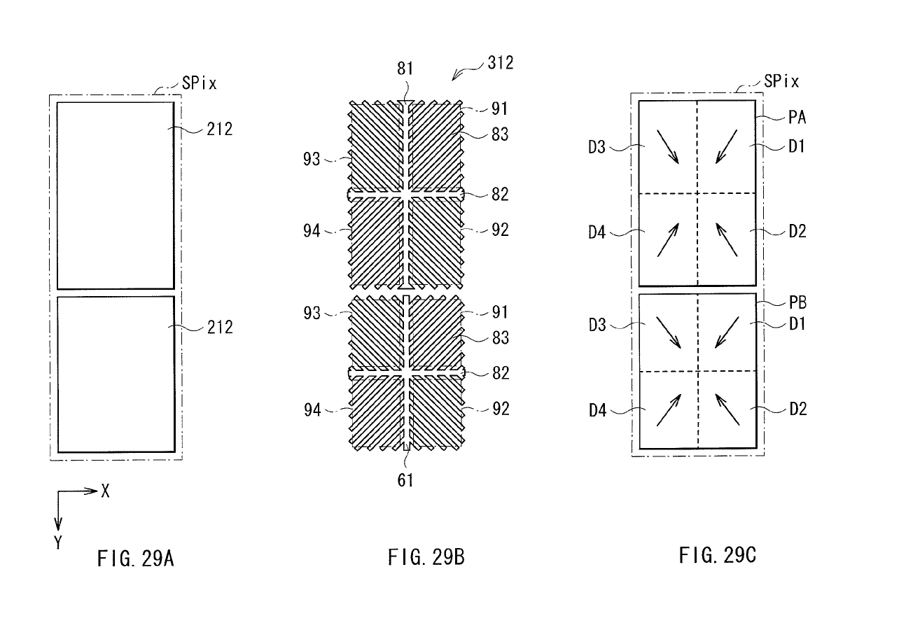

FIGS. 29A, 29B, and 29C illustrate a configuration example of the display section 60. FIG. 29A illustrates the pixel electrode 212, FIG. 29B illustrates the transparent electrode 312, and FIG. 29C schematically illustrates alignment of the liquid crystal molecules M in the sub-pixel SPix.

The transparent electrodes 312 in the sub-pixel portions PA and PB are formed in a similar electrode pattern. As illustrated in FIG. 29B, each of the transparent electrodes 312 includes trunk portions 81 and 82 and branch portions 83. The trunk portion 81 is so formed as to extend in the vertical direction Y, and the trunk portion 82 is so formed as to extend in the horizontal direction X and as to intersect with the trunk portion 81. The branch portions 83 in each of four branch regions 91 to 94 separated by the trunk portion 81 and the trunk portion 82 are so formed as to extend from the trunk portion 81 and the trunk portion 82.

The branch portions 83 in each of the branch regions 91 to 94 extend in a same direction. An extending direction of the branch portions 83 in the branch region 91 and an extending direction of the branch portions 83 in the branch region 93 are line-symmetrically arranged with respect to the vertical direction Y as an axis, and an extending direction of the branch portions 83 in the branch region 92 and an extending direction of the branch portions 83 in the branch region 94 are line-symmetrically arranged with respect to the vertical direction Y as an axis in a similar manner. Moreover, the extending direction of the branch portions 83 in the branch region 91 and the extending direction of the branch portions 83 in the branch region 92 are line-symmetrically arranged with respect to the horizontal direction X as an axis, and the extending direction of the branch portions 83 in the branch region 93 and the extending direction of the branch portions 83 in the branch region 94 are line-symmetrically arranged with respect to the horizontal direction X as an axis in a similar manner. In this example, more specifically, the branch portions 83 in each of the branch regions 91 and 94 extend in a direction rotated counterclockwise by a predetermined angle φ (for example, 45°) from the horizontal direction X, and the branch portions 83 in each of the branch regions 92 and 93 extend in a direction rotated clockwise by a predetermined angle φ (for example, 45°) from the horizontal direction X.

The transparent electrode 312 correspond to a specific example of “third electrode” in an embodiment of the disclosure.

In a process of manufacturing a display section 60, after the display section 60 is assembled, the display section 60 is irradiated with UV light while applying a voltage between the transparent electrodes 312 and the counter electrode 222 so as to pretilt the liquid crystal molecules M in the liquid crystal layer 200, thereby determining alignment of the liquid crystal molecules M. Therefore, as illustrated in FIG. 29C, in each of the sub-pixels SPix, four domains D1 to D4 are formed in each of the sub-pixel portions PA and PB. The domains D1 to D4 are formed corresponding to the branch regions 91 to 94, respectively.

When the display section 60 performs a display operation, a same pixel signal is applied to, for example, the pixel electrode 212 and the transparent electrode 312 corresponding to the pixel electrode 212. Therefore, in the display section 60, since the liquid crystal layer 200 is driven by mainly a potential difference between the pixel electrode 212 and the counter electrode 222, scattering of light in the liquid crystal layer 200 is allowed to be reduced. In other words, for example, in the display section 20S according to Comparative Example 2, the liquid crystal layer 200S is driven by a potential difference between the pixel electrode 212R (refer to FIG. 19A) and the counter electrode 222. In this case, the liquid crystal molecules M are aligned in a direction according to the electrode pattern of the pixel electrode 212R; therefore, light may be scattered in the liquid crystal layer 200S by periodicity of alignment of the liquid crystal molecules M. On the other hand, in the display section 60 according to the embodiment, the liquid crystal layer 200 is driven by mainly a potential difference between the pixel electrode 212 and the counter electrode 222; therefore, alignment of the liquid crystal molecules M in the liquid crystal layer 200 is allowed to be substantially uniform. Thus, scattering of light in the liquid crystal layer 200 is allowed to be reduced, and image quality is allowed to be enhanced.

As described above, in the embodiment, since the pixel electrodes and the counter electrode are uniformly formed in each of the sub-pixels, scattering of light in the liquid crystal layer is allowed to be reduced, and image quality is allowed to be enhanced.

### [Modification 2-1]

In the above-described embodiment, each of the sub-pixels SPix includes the sub-pixel portions PA and PB; however, the configuration of each of the sub-pixels SPix is not limited thereto. For example, as with the modification 1-2 of the first embodiment, each of the sub-pixels SPix may not include sub-pixel portions, and may be driven as one unit.

### [Modification 2-2]

In the above-described embodiment, the width W12 of each of the opening-closing sections 12 are substantially equal to the sub-pixel pitch PS; however, the width W12 is not limited thereto, and, for example, as with Modification 1-3 of the first embodiment, the width W12 may be substantially equal to an integral multiple (for example, twice) of the sub-pixel pitch PS.

### 3. Third Embodiment

Next, a stereoscopic display unit 3 according to a third embodiment will be described below. In the embodiment, a display section 70 is configured of a so-called PVA type. It is to be noted that like components are denoted by like numerals as of the stereoscopic display unit 1 according to the above-described first embodiment and the like and will not be further described.

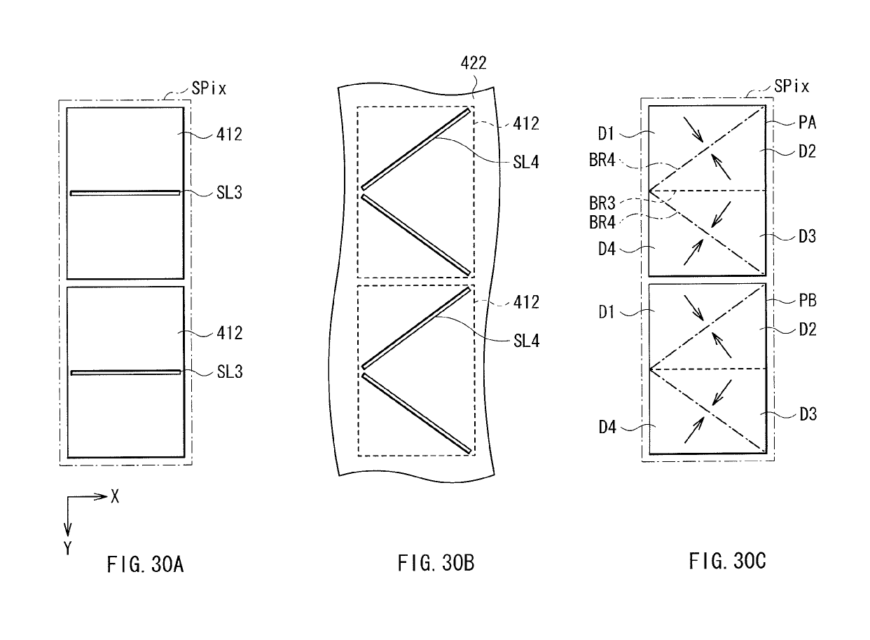

FIGS. 30A, 30B, and 30C illustrate a configuration example of the display section 70. FIG. 30A illustrates a pixel electrode 412, FIG. 30B illustrates a counter electrode 422, and FIG. 30C schematically illustrates alignment of the liquid crystal molecules M in the sub-pixel SPix.

The pixel electrodes 412 in the sub-pixel portions PA and PB are formed in a similar electrode pattern. As illustrated in FIG. 30A, one slit SL3 is formed in each of the pixel electrodes 412. In this example, the slit SL3 is so formed as to extend in the horizontal direction X around a center of the pixel electrode 412.

As illustrated in FIG. 30B, in the counter electrode 422, two slits SL4 are formed in each of the sub-pixel portions PA and PB. In this example, one of the two slit SL4 is so formed as to extend in a direction from bottom left to top right in an upper half of each of the sub-pixel portions PA and PB, and the other slit SL4 is so formed as to extend in a direction from top left to bottom right in a lower half of each of the sub-pixel portions PA and PB.

Thus, as illustrated in FIG. 30C, four domains D1 to D4 are formed in each of the sub-pixels SPix. In other words, the domains D1 and D2 are formed through separating the upper half of each of the sub-pixel portions PA and PB by a domain boundary BR4 corresponding to the slit SL4, and the domains D3 and D4 are formed through separating the lower half of each of the sub-pixel portions PA and PB by the domain boundary BR4. Moreover, the domains D2 and D3 are separated by a domain boundary BR3 corresponding to the slit SL3.

Thus, each of the sub-pixel portions PA and PB includes four domains D1 to D4. At this time, in the display section 70, the number of slits SL3 and the number of slits SL4 are reduced: therefore, possibility of scattering of light is allowed to be reduced. In other words, for example, in the display section 20R according to Comparative Example 1, as illustrated in FIGS. 16A to 16C, a plurality of slits SL1 and a plurality of slits SL2 are provided, and in the upper half of the sub-pixel SPixR, the domains DR1 and DR2 are alternately formed, and in the lower half of the sub-pixel SPixR, the domains DR3 and DR4 are alternately formed. Therefore, each of the domains DR1 to DR4 is arranged separately in a plurality of regions, and accordingly, light may be scattered in the liquid crystal layer 200R by periodicity of alignment of the liquid crystal molecules M. On the other hand, in the display section 70 according to the embodiment, since the number of slits SL3 and the number of slits SL4 are reduced and each of the domains D1 to D4 is formed in a closed region, scattering of light in the liquid crystal layer 200 is allowed to be reduced. Therefore, in the stereoscopic display unit 3, image quality is allowed to be enhanced.

As described above, in the embodiment, since the number of slits formed in the pixel electrodes and the counter electrode in each of the sub-pixels is reduced, image quality is allowed to be enhanced.

### [Modification 3-1]

In the above-described embodiment, each of the sub-pixels SPix includes the sub-pixel portions PA and PB; however, the configuration of each of the sub-pixels SPix is not limited thereto. For example, as with the modification 1-2 of the first embodiment, each of the sub-pixels SPix may not include sub-pixel portions, and may be driven as one unit.

### [Modification 3-2]

In the above-described embodiment, the width W12 of each of the opening-closing sections 12 are substantially equal to the sub-pixel pitch PS; however, the width W12 is not limited thereto, and, for example, as with Modification 1-3 of the first embodiment, the width W12 may be substantially equal to an integral multiple (for example, twice) of the sub-pixel pitch PS.

### [Modification 3-3]

In the above-described embodiment, one slit SL3 is provided to each of the pixel electrodes 412, and two silts SL4 are provided to each of the sub-pixel portions PA and PB in the counter electrode 422; however, the configuration of the display section 70 is not limited thereto. For example, two slits corresponding to the two slits SL4 may be provided to each of the pixel electrodes, and a slit corresponding to the one slit SL3 may be provided to each of the sub-pixel portions PA and PB in the counter electrode.

### [Modification 3-4]

As with the second embodiment, the liquid crystal molecules M may be pretilted by UV irradiation. In this case, the alignment direction of the liquid crystal molecules M is allowed to be further stabilized, and response time is allowed to be reduced.

### 4. Fourth Embodiment

Next, a stereoscopic display unit 4 according to a fourth embodiment will be described below. In the embodiment, a display section 80 is configured of so-called pinhole type pixels. It is to be noted that like components are denoted by like numerals as of the stereoscopic display unit 1 according to the above-described first embodiment and the like and will not be further described.

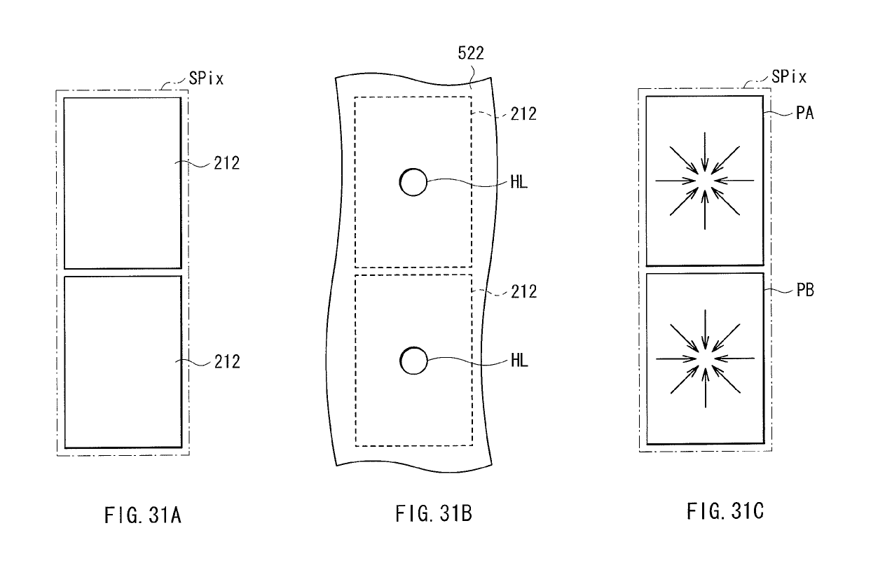

FIGS. 31A, 31B, and 31C illustrate a configuration example of the display section 80. FIG. 31A illustrates the pixel electrode 212, FIG. 31B illustrates a counter electrode 522, and FIG. 31C schematically illustrates alignment of the liquid crystal molecules M in the sub-pixel SPix. As illustrated in FIG. 31B, in the counter electrode 522, holes HL are formed in respective regions corresponding to the sub-pixel portions PA and PB. In this example, each of the holes HL is formed at a position corresponding to a center of each of the pixel electrodes 212. Therefore, in the sub-pixel SPix, as illustrated in FIG. 31C, the liquid crystal molecules M are radially aligned in each of the sub-pixel portions PA and PB. In other words, in each of the sub-pixel portions PA and PB, very small domains are radially arranged.

In the display section 80, the pixel electrodes 212 are uniformly formed in the sub-pixel portions PA and PB, and the counter electrode 522 is also uniformly formed, except for the holes HL; therefore, possibility of scattering of light is allowed to be reduced. In other words, for example, in the display section 20R according to Comparative Example 1 (refer to FIGS. 16A to 16C) and the display section 20S according to Comparative Example 2 (refer to FIGS. 19A to 19C), light may be scattered by the electrode pattern or the like (refer to FIGS. 18 and 20). On the other hand, in the display section 80 according to the embodiment, the pixel electrodes 212 and the counter electrode 522 are substantially uniformly formed; therefore, possibility of scattering of light by the electrode pattern or the like is allowed to be reduced. Thus, in the stereoscopic display unit 4, image quality is allowed to be enhanced.

As described above, in the embodiment, since the pixel electrodes and the counter electrode are simply configured in each of the sub-pixels, possibility of scattering of light by these electrode patterns is allowed to be reduced, and image quality is allowed to be enhanced.

### [Modification 4-1]

In the above-described embodiment, each of the sub-pixels SPix includes the sub-pixel portions PA and PB; however, the configuration of each of the sub-pixels SPix is not limited thereto. For example, as with the modification 1-2 of the first embodiment, each of the sub-pixels SPix may not include sub-pixel portions, and may be driven as one unit.

### [Modification 4-2]

In the above-described embodiment, the width W12 of each of the opening-closing sections 12 are substantially equal to the sub-pixel pitch PS; however, the width W12 is not limited thereto, and, for example, as with Modification 1-3 of the first embodiment, the width W12 may be substantially equal to an integral multiple (for example, twice) of the sub-pixel pitch PS.

### 5. Fifth Embodiment

Next, a stereoscopic display unit 5 according to a fifth embodiment will be described below. In the embodiment, a display section 90 is made of a TN (Twisted Nematic) liquid crystal. It is to be noted that like components are denoted by like numerals as of the stereoscopic display unit 1 according to the above-described first embodiment and the like and will not be further described.

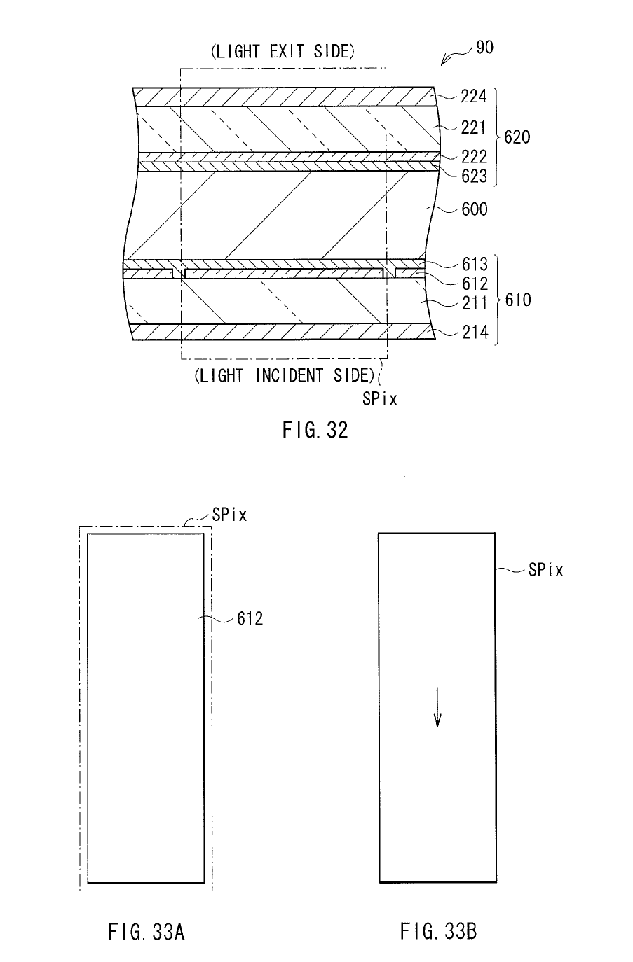

FIG. 32 illustrates a configuration example of the display section 90. The display section 90 is different from the display section 20 according to the first embodiment in that the sub-pixel portions are not provided, and the sub-pixel SPix is driven as one unit.

The display section 90 includes a drive substrate 610, a counter substrate 620, and a liquid crystal layer 600. The drive substrate 610 includes pixel electrodes 612 and an alignment film 613. Each of the pixel electrodes 612 may be configured of, for example, a transparent conductive film of ITO or the like, and is uniformly formed in a region corresponding to each of the sub-pixels SPix. The alignment film 613 is formed on the pixel electrodes 612. The counter substrate 620 includes an alignment film 623. As will be described later, a direction (an alignment direction) in which the liquid crystal molecules M are aligned by the alignment film 623 is set to intersect with a direction in which the liquid crystal molecules M are aligned by the alignment film 613. The liquid crystal layer 600 is made of a TN liquid crystal.

FIGS. 33A and 33B illustrate a configuration example of the display section 90. FIG. 33A illustrates the pixel electrode 612, and the FIG. 33B schematically illustrates alignment of the liquid crystal molecules M in the sub-pixel SPix. As illustrated in FIG. 33A, each of the pixel electrodes 612 is uniformly formed in each of the sub-pixels SPix. Moreover, as illustrated in FIG. 33B, the display section 90 operates to align the liquid crystal molecules M in a uniform direction in each of the sub-pixels SPix. In other words, the display section 90 is a single-domain display panel.

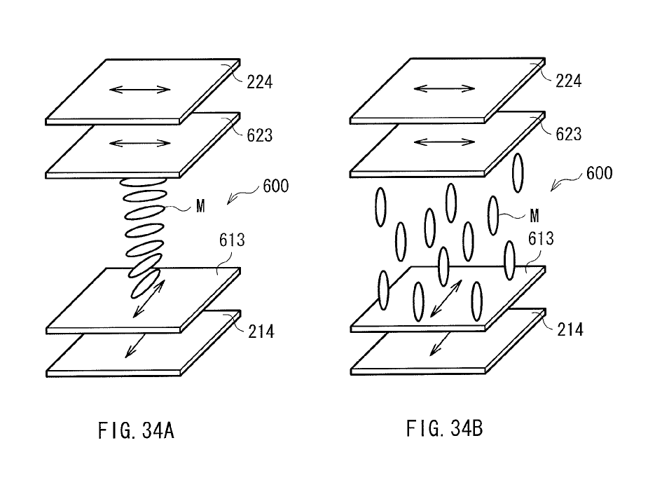

FIGS. 34A and 34B schematically illustrate an operation of the liquid crystal layer 600 in the case where a potential difference does not exist between the pixel electrode 612 and the counter electrode 222 and in the case where a potential difference exists between the pixel electrode 612 and the counter electrode 222, respectively.

In the case where a potential difference does not exist, as illustrated in FIG. 34A, long axes of the liquid crystal molecules M in the liquid crystal layer 600 are aligned in a direction parallel to a substrate surface of the drive substrate 610 or the counter substrate 620. Long axes of liquid crystal molecules M in proximity to the alignment film 613 are aligned in a predetermined direction by the alignment film 613, and long axes of liquid crystal molecules M in proximity to the alignment film 623 are aligned in a predetermined direction by the alignment film 623. At this time, the alignment direction of the liquid crystal molecules M aligned by the alignment film 613 and the alignment direction of the liquid crystal molecules M aligned by the alignment film 623 intersect with each other, and liquid crystal molecules M in the liquid crystal layer 600 are so aligned as to be twisted.

On the other hand, in the case where a potential difference exists, as illustrated in FIG. 34B, long axes of the liquid crystal molecules M in the liquid crystal layer 600 are aligned in a direction perpendicular to the substrate surface of the drive substrate 610 or the counter substrate 620.

As described above, in the embodiment, since the pixel electrode and the counter electrode are uniformly formed in each of the sub-pixels SPix, possibility of scattering of light by these electrode patterns is allowed to be reduced, and image quality is allowed to be enhanced.

### [Modification 5-1]

In the above-described embodiment, the width W12 of each of the opening-closing sections 12 are substantially equal to the sub-pixel pitch PS; however, the width W12 is not limited thereto, and, for example, as with Modification 1-3 of the first embodiment, the width W12 may be substantially equal to an integral multiple (for example, twice) of the sub-pixel pitch PS.

### 6. Application Examples

Next, application examples of the stereoscopic display units described in the above-described embodiments and the modification thereof will be described below.

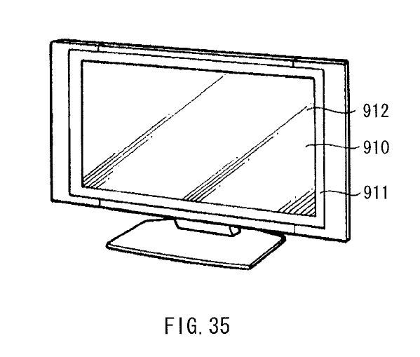

FIG. 35 illustrates an appearance of a television to which any one of the stereoscopic display units according to the above-described embodiments and the like is applied. The television may include, for example, an image display screen section 910 including a front panel 911 and a filter glass 912. The television is configured of any one of the stereoscopic display units according to the above-described embodiments and the like.

The stereoscopic display units according to the above-described embodiments and the like are applicable to, in addition to such a television, electronic apparatuses in any fields, including digital cameras, notebook personal computers, portable terminal devices such as cellular phones, portable game machines, and video cameras. In other words, the stereoscopic display units according to the above-described embodiments and the like are applicable to electronic apparatuses in any fields displaying an image.

Although the technology of the present disclosure is described referring to some embodiments, the modifications, and the application examples to electronic apparatuses, the technology is not limited thereto, and may be variously modified.

For example, in the above-described first to fourth embodiments and the like, four domains are formed in each of the sub-pixel portions PA and PB; however, the number of domains are not limited to four. For example, three or less domains or five or more domains may be formed in each of the sub-pixel portions PA and PB.

Moreover, for example, in the above-described embodiments and the like, the opening-closing sections 12 are divided into four groups; however, the number of groups is not limited thereto, and the opening-closing sections 12 may be divided into three or less groups, or five or more groups. Moreover, the opening-closing sections 12 may not be divided into groups. In this case, the opening-closing sections are constantly in the open state (the transmission state) during stereoscopic display.

Further, for example, in the above-described embodiments and the like, eight perspective images are displayed during stereoscopic display; however, the number of perspective images to be displayed is not limited thereto, and seven or less perspective images or nine or more perspective images may be displayed. In this case, a relative positional relationship between the opening-closing sections 12A to 12D of the barrier section 10 and the sub-pixels SPix illustrated in FIGS. 11A and 11B is also varied. More specifically, for example, in the case where nine perspective images are displayed, each one of the opening-closing sections 12A to 12D may be assigned to nine sub-pixels SPix in the display section 20.

For example, the stereoscopic display units in the above-described embodiments and the like are of a parallax barrier type; however, the stereoscopic display units are not limited thereto, and may be of, for example, a lenticular lens type.

It is to be noted that the technology is allowed to have the following configurations.

(1) A display including:

a liquid crystal display section including first electrodes, a liquid crystal layer, and a second electrode, the first electrodes corresponding to a plurality of unit pixels, the second electrode being disposed to face the first electrodes with the liquid crystal layer in between;

a backlight; and

a light-ray control section inserted between the liquid crystal display section and the backlight,

in which each of the unit pixels includes a plurality of domains or a single domain, the plurality of domains in which liquid crystal alignment differs between the domains, and

each of the first electrodes is uniformly formed in each of the plurality of domains or the single domain.

(2) The display unit according to (1), in which

each of the unit pixels includes a plurality of domains, and

each of the domains is configured as a one successive region.

(3) The display unit according to (2), in which

the liquid crystal display section includes

a first alignment film disposed between the liquid crystal layer and the first electrodes, and including a plurality of first alignment regions determining the liquid crystal alignment, and

a second alignment film disposed between the liquid crystal layer and the second electrode, and including a plurality of second alignment regions determining the liquid crystal alignment, and

the domains are regions determined by the first alignment regions and the second alignment regions.

(4) The display unit according to (3), in which

the first alignment film includes two first alignment regions in a region corresponding to each of the unit pixels, the two first alignment regions being arranged side by side,

the second alignment film includes two second alignment regions in a region corresponding to each of the unit pixels, the two second alignment regions being arranged side by side in a direction intersecting with a direction in which the two first alignment regions are arranged side by side, and

each of the unit pixels includes four domains.

(5) The display unit according to (2), in which

the liquid crystal display section includes a third electrode disposed between the first electrodes and the second liquid crystal layer,

the third electrode includes a plurality of branch regions, each of the branch regions including branch portions extending in a same direction, and

the domains are regions corresponding to the branch regions.

(6) The display unit according to (5), in which

the third electrode further includes

a first trunk portion, and

a second trunk portion intersecting with the first trunk portion,

the branch regions are four regions separated by the first trunk portion and the second trunk portion, and

the branch portions in the respective branch regions extend from the first trunk portion and the second trunk portion in a direction differing between the branch regions.

(7) The display unit according to (2), in which

each of the first electrodes includes one or two first slits,

the second electrode includes one or two second slits in a region corresponding to each of the unit pixels, the one or two second slits being formed in portions different from the one or two first slits, and

the domains are regions determined by the one or two first silts and the one or two second slits.

(8) The display unit according to (7), in which

each of the first electrodes includes one first slit, and

the second electrode includes one second slit in each of two sub-regions formed through separating a region corresponding to each of the unit pixels by the first slit.

(9) The display unit according to (2), in which

the second electrode includes holes in portions corresponding to the unit pixels, and

the domains are regions arranged around each of the holes.

(10) The display unit according to (1), in which

each of the unit pixels includes a single domain,

the liquid crystal layer is made of a TN liquid crystal, and

the domain is a region corresponding to each of the unit pixels.

(11) The display unit according to any one of (1) to (9), in which

each of the unit pixels includes a plurality of domains, and

areas of the domains are substantially equal to one another.

(12) The display unit according to any one of (1) to (11), in which

the liquid crystal display section includes a plurality of pixels,

each of the pixels includes a plurality of sub-pixels, and

each of the sub-pixels includes a plurality of the unit pixels.

(13) The display unit according to any one of (1) to (11), in which

the liquid crystal display section includes a plurality of pixels,

each of the pixels includes a plurality of sub-pixels, and

the sub-pixels are the unit pixels.

(14) The display unit according to any one of (1) to (13), in which the light-ray control section is a barrier section allowing light to pass therethrough or blocking the light.

(15) The display unit according to (14), in which the barrier section includes a plurality of liquid crystal barriers in a first group and a plurality of liquid crystal barriers in a second group, the liquid crystal barriers in the first group and the liquid crystal barriers in the second groups extending in a first direction and being alternately arranged side by side in a second direction.

(16) The display unit according to (15), in which

the display unit has a plurality of display modes including a first display mode and a second display mode,

in the first display mode, the liquid crystal display section displays a plurality of perspective images, and the barrier section operates to turn the liquid crystal barriers in the first group into a transmission state and to turn the liquid crystal barriers in the second group into a blocking state, thereby allowing light rays toward the respective perspective images to be oriented in respective angle directions limited corresponding to the respective light rays, and

in the second display mode, the liquid crystal display section displays a single perspective image, and the barrier section operates to turn the liquid crystal barriers in the first group and the liquid crystal barriers in the second group into a transmission state, thereby allowing light rays toward the single perspective image to pass therethrough.

(17) The display unit according to (15) or (16), in which a width of each of the liquid crystal barriers in the first group is substantially equal to a pitch of the unit pixel in the second direction.

(18) A display unit including:

a liquid crystal display section including first electrodes, a liquid crystal layer, and a second electrode, the first electrodes corresponding to a plurality of unit pixels, the second electrode being disposed to face the first electrodes with the liquid crystal layer in between;

a backlight; and

a light-ray control section inserted between the liquid crystal display section and the backlight,

in which each of the first electrodes is uniformly formed in each of the unit pixels, and

the second electrode has holes in portions corresponding to the respective unit pixels.

(19) An electronic apparatus provided with a display unit and a control section which performs operation control with use of the display unit, the display unit including:

a liquid crystal display section including first electrodes, a liquid crystal layer, and a second electrode, the first electrodes corresponding to a plurality of unit pixels, the second electrode being disposed to face the first electrodes with the liquid crystal layer in between;

a backlight; and

a light-ray control section inserted between the liquid crystal display section and the backlight,

in which each of the unit pixels includes a plurality of domains or a single domain, the plurality of domains in which liquid crystal alignment differs between the domains, and

each of the first electrodes is uniformly formed in each of the plurality of domains or the single domain.

The present disclosure contains subject matter related to that disclosed in Japanese Priority Patent Application No. 2012-152723 filed in the Japan Patent Office on Jul. 6, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a liquid crystal display section including first electrodes, a liquid crystal layer, and a second electrode, the first electrodes corresponding to a plurality of unit pixels, the second electrode being disposed to face the first electrodes with the liquid crystal layer in between;
a backlight; and
a light-ray control section inserted between the liquid crystal display section and the backlight,
wherein each of the unit pixels includes a plurality of domains or a single domain, the plurality of domains in which liquid crystal alignment differs between the domains, and
each of the first electrodes is uniformly formed in each of the plurality of domains or the single domain.

2. The display unit according to claim 1, wherein
each of the unit pixels includes a plurality of domains, and
each of the domains is configured as a one successive region.

3. The display unit according to claim 2, wherein
the liquid crystal display section includes
a first alignment film disposed between the liquid crystal layer and the first electrodes, and including a plurality of first alignment regions determining the liquid crystal alignment, and
a second alignment film disposed between the liquid crystal layer and the second electrode, and including a plurality of second alignment regions determining the liquid crystal alignment, and
the domains are regions determined by the first alignment regions and the second alignment regions.

4. The display unit according to claim 3, wherein
the first alignment film includes two first alignment regions in a region corresponding to each of the unit pixels, the two first alignment regions being arranged side by side,
the second alignment film includes two second alignment regions in a region corresponding to each of the unit pixels, the two second alignment regions being arranged side by side in a direction intersecting with a direction in which the two first alignment regions are arranged side by side, and
each of the unit pixels includes four domains.

5. The display unit according to claim 2, wherein
the liquid crystal display section includes a third electrode disposed between the first electrodes and the second liquid crystal layer,
the third electrode includes a plurality of branch regions, each of the branch regions including branch portions extending in a same direction, and
the domains are regions corresponding to the branch regions.

6. The display unit according to claim 5, wherein
the third electrode further includes
a first trunk portion, and
a second trunk portion intersecting with the first trunk portion,
the branch regions are four regions separated by the first trunk portion and the second trunk portion, and
the branch portions in the respective branch regions extend from the first trunk portion and the second trunk portion in a direction differing between the branch regions.

7. The display unit according to claim 2, wherein
each of the first electrodes includes one or two first slits,
the second electrode includes one or two second slits in a region corresponding to each of the unit pixels, the one or two second slits being formed in portions different from the one or two first slits, and
the domains are regions determined by the one or two first silts and the one or two second slits.

8. The display unit according to claim 7, wherein
each of the first electrodes includes one first slit, and
the second electrode includes one second slit in each of two sub-regions formed through separating a region corresponding to each of the unit pixels by the first slit.

9. The display unit according to claim 2, wherein
the second electrode includes holes in portions corresponding to the unit pixels, and
the domains are regions arranged around each of the holes.

10. The display unit according to claim 1, wherein
each of the unit pixels includes a single domain,
the liquid crystal layer is made of a TN liquid crystal, and
the domain is a region corresponding to each of the unit pixels.

11. The display unit according to claim 1, wherein
each of the unit pixels includes a plurality of domains, and
areas of the domains are substantially equal to one another.

12. The display unit according to claim 1, wherein
the liquid crystal display section includes a plurality of pixels,
each of the pixels includes a plurality of sub-pixels, and
each of the sub-pixels includes a plurality of the unit pixels.

13. The display unit according to claim 1, wherein
the liquid crystal display section includes a plurality of pixels,
each of the pixels includes a plurality of sub-pixels, and
the sub-pixels are the unit pixels.

14. The display unit according to claim 1, wherein the light-ray control section is a barrier section allowing light to pass therethrough or blocking the light.

15. The display unit according to claim 14, wherein the barrier section includes a plurality of liquid crystal barriers in a first group and a plurality of liquid crystal barriers in a second group, the liquid crystal barriers in the first group and the liquid crystal barriers in the second groups extending in a first direction and being alternately arranged side by side in a second direction.

16. The display unit according to claim 15, wherein
the display unit has a plurality of display modes including a first display mode and a second display mode,
in the first display mode, the liquid crystal display section displays a plurality of perspective images, and the barrier section operates to turn the liquid crystal barriers in the first group into a transmission state and to turn the liquid crystal barriers in the second group into a blocking state, thereby allowing light rays toward the respective perspective images to be oriented in respective angle directions limited corresponding to the respective light rays, and
in the second display mode, the liquid crystal display section displays a single perspective image, and the barrier section operates to turn the liquid crystal barriers in the first group and the liquid crystal barriers in the second group into a transmission state, thereby allowing light rays toward the single perspective image to pass therethrough.

17. The display unit according to claim 15, wherein a width of each of the liquid crystal barriers in the first group is substantially equal to a pitch of the unit pixel in the second direction.

18. A display unit comprising:
a liquid crystal display section including first electrodes, a liquid crystal layer, and a second electrode, the first electrodes corresponding to a plurality of unit pixels, the second electrode being disposed to face the first electrodes with the liquid crystal layer in between;
a backlight; and
a light-ray control section inserted between the liquid crystal display section and the backlight,
wherein each of the first electrodes is uniformly formed in each of the unit pixels, and
the second electrode has holes in portions corresponding to the respective unit pixels.

19. An electronic apparatus provided with a display unit and a control section which performs operation control with use of the display unit, the display unit comprising:
a liquid crystal display section including first electrodes, a liquid crystal layer, and a second electrode, the first electrodes corresponding to a plurality of unit pixels, the second electrode being disposed to face the first electrodes with the liquid crystal layer in between;
a backlight; and
a light-ray control section inserted between the liquid crystal display section and the backlight,
wherein each of the unit pixels includes a plurality of domains or a single domain, the plurality of domains in which liquid crystal alignment differs between the domains, and
each of the first electrodes is uniformly formed in each of the plurality of domains or the single domain.
